(19) United States
(12) Patent Application Publication
(10) Pub. No.: US 2026/0320937 A1
(43) Pub. Date: Oct. 15, 2026

(54) AI-GENERATED VIDEO HOLOGRAMS FOR WEB, MOBILE, & XR

(71) Applicants: Josh Lehman, Las Vegas, NV (US); Sean McCue, Las Vegas, NV (US); Matias Gelos, Las Vegas, NV (US)

(72) Inventors: Josh Lehman, Las Vegas, NV (US); Sean McCue, Las Vegas, NV (US); Matias Gelos, Las Vegas, NV (US)

(21) Appl. No.: 19/716,921

(22) Filed: Jun. 23, 2026

Related U.S. Application Data
(63) Continuation-in-part of application No. 18/910,478, filed on Oct. 9, 2024.
Application No. 18/910,478 is a continuation of application No. 18/104,097, filed on Jan. 31, 2023, now Pat. No. 12,118,681.
Application No. 18/104,097 is a continuation of application No. 17/385,664, filed on Jul. 26, 2021, now Pat. No. 11,568,613.
Application No. 17/385,664 is a continuation of application No. 16/924,323, filed on Jul. 9, 2020, now Pat. No. 11,074,759.
(60) Provisional application No. 62/872,035, filed on Jul. 9, 2019.
(60) Provisional application No. 63/828,777, filed on Jun. 23, 2025.

(51) Int. Cl. G06T 19/00; G06T 7/20; G06T 19/20; H04N 9/75

(52) U.S. Cl. CPC G06T 19/006; G06T 7/20; G06T 19/20; G06T 2219/2004; H04N 9/75

(57) ABSTRACT

Systems and methods are disclosed for generating and rendering AI-generated holographic media. A content generator including a generative video engine synthesizes still or video holographic media representing a subject, person, object, prop, scene, or environment based on parameterized cinematography tokens, such as lighting, lens parameters, motion paths, depth of field, camera motion, or color grading. The generated media may be output with a keyed background or alpha-channel transparency and encoded in one or more formats, including two-dimensional, stereoscopic three-dimensional, spatial multi-view, 180-degree, or 360-degree media. A playback stack includes an adaptive decoder and a GPU-executed shader that removes keyed backgrounds or composites alpha-channel data to render transparent holographic media on web, mobile, AR, VR, MR, XR, or other display devices.

### CROSS-REFERENCE TO RELATED APPLICATIONS

This application is a Continuation-in-Part of U.S. patent application Ser. No. 18/910,478, filed Oct. 9, 2024, which is a Continuation of U.S. patent application Ser. No. 18/104,097, filed Jan. 31, 2023, which is a Continuation of U.S. patent application Ser. No. 17/385,664, filed Jul. 26, 2021, which is a Continuation of U.S. patent application Ser. No. 16/924,323, filed Jul. 9, 2020, which claims the benefit of priority to U.S. Provisional Application No. 62/872,035, filed Jul. 9, 2019, each of which are incorporated herein by reference as if set forth in its entireties. Furthermore, this application claims the benefit of priority to U.S. Provisional Application No. 63/828,777, filed Jun. 23, 2025, which is also incorporated herein by reference as if set forth its entirety.

### BACKGROUND

### Field of the Disclosure

The disclosure relates generally to holograms and virtual reality, and, more particularly, to an apparatus, system, and method of providing AI-generated video holograms for web, mobile and extended reality (XR).

### Background of the Disclosure

Conventional green-screen studio workflows are limited. Production teams still rely on traditional green-screen studios to create composited video of subjects onto different backgrounds.

However, this conventional approach faces four persistent obstacles:

High On-Set Overhead: large physical sets, uniform chroma backdrops, calibrated lighting grids, camera rigs, and crew all drive up hourly costs. Scheduling talent and studio time further inflates budgets-often beyond the reach of smaller enterprises or rapid-iteration projects.

Labor-Intensive Post-Production: manual keying, edge cleanup, spill suppression, rotoscoping, and colour correction demand specialised artists and lengthy render times. Each revision or alternate background triggers another round of compositing and quality control.

Limited Flexibility and Re-usability: a new scene, camera angle, or aspect ratio usually means a reshoot. Delivering the same performance in 2D, stereoscopic, spatial-video (multi-view), 180°, and 360° formats requires multiple setups or extensive conversion work, delaying distribution.

Distribution Constraints: high-resolution chroma-key footage remains bandwidth-heavy, while mobile browsers and lightweight extended reality (XR) devices often struggle with real-time decoding and playback consistency. These constraints restrict green-screen holographic content to high-budget productions, leaving education, e-commerce, training, and live events without a scalable, cost-effective pipeline.

Therefore, the need exists for an apparatus, system, and method of providing AI-generated video holograms for web, mobile and XR.

### SUMMARY OF THE DISCLOSURE

Aspects of the disclosure relate to a system for providing AI-generated holograms having one or more processors configured to implement a content generator including a generative video engine, the content generator configured to synthesize holographic media representing at least one subject, person, object, prop, scene, or environment based at least in part on parameterized cinematography tokens including at least one of lighting, a lens parameter, a motion path, depth of field, camera motion, or color grading, and a playback stack including a shader executable by a graphics processing unit, the shader configured to remove a keyed background from the holographic media or to composite the holographic media using alpha-channel data.

In some embodiments, the content generator further comprises a background selector configured to output the holographic media with a background selected from the group consisting of a solid green background, a user-defined keyed-color background, and a transparent background.

In some embodiments, the content generator further includes a multi-format encoder configured to encode synchronized outputs of the holographic media in at least one format selected from the group consisting of two-dimensional video, stereoscopic three-dimensional video, spatial multi-view video, 180-degree video, and 360-degree video.

In some embodiments, the playback stack further comprises an adaptive decoder configured to use a hardware codec pipeline of a host device to decode the holographic media. In some embodiments, the content generator is configured to generate still holographic media or video holographic media for real-time live use or post-production of pre-recorded media.

In some embodiments, the shader is configured to apply at least one of a chroma-key threshold, a slope parameter, an edge-smoothing parameter, an opacity parameter, or a spill-suppression parameter to refine a boundary of the at least one subject, person, object, prop, scene, or environment. In some embodiments, the holographic media comprises stereoscopic or spatial-view media, and wherein the shader is configured to apply background removal or alpha compositing separately to a plurality of views of the stereoscopic or spatial-view media.

In some embodiments, the playback stack is configured to receive the holographic media as a real-time stream and render the holographic media as a transparent overlay on a web browser, mobile device, AR headset, VR headset, MR headset, XR headset, or AR glasses. In some embodiments, the one or more processors are configured to receive environmental data from a presentation device and place the holographic media at a selected position relative to a detected surface, focal plane, anchor point, or depth map of a physical or virtual environment.

In some embodiments, an artificial intelligence model is configured to modify at least one of generation, encoding, streaming, or rendering of the holographic media based on device capability, network bandwidth, frame rate, latency, segmentation quality, shader performance, or user feedback.

Aspects of the disclosure relate to a method for providing AI-generated holographic media having the steps of receiving, by one or more processors, a content-generation request defining at least one subject, person, object, prop, scene, or environment, synthesizing, using a generative video engine, holographic media representing the at least one subject, person, object, prop, scene, or environment based at least in part on parameterized cinematography tokens, selecting a background mode for the holographic media, the background mode comprising a keyed background or alpha-channel transparency, encoding the holographic media in at least one playback format, and rendering the holographic media using a shader executed by a graphics processing unit, wherein the shader removes the keyed background from the holographic media or composites the holographic media using alpha-channel data.

In some embodiments, the content-generation request comprises at least one of a text prompt, reference image, reference video, script, audio input, three-dimensional model, style reference, user preference, or cinematography parameter. In some embodiments, an artificial intelligence model predicts, based on a target presentation device or network condition, at least one of an output format, codec, resolution, frame rate, stereoscopic arrangement, spatial-view arrangement, or rendering path for the holographic media.

In some embodiments, an artificial intelligence model modifies at least one of a chroma-key color, chroma-key threshold, alpha mask, edge-smoothing parameter, spill-suppression parameter, output resolution, frame rate, or codec in response to detected playback performance. In some embodiments, the method further includes the step of generating, using an artificial intelligence model, a recommendation to change at least one of a prompt, lighting parameter, lens parameter, camera motion, depth-of-field parameter, background mode, output format, or placement location of the holographic media.

In some embodiments, the method further includes the step of displaying to a user a preview of the holographic media on at least one selectable background mode including a keyed-color background, transparent background, physical environment background, or virtual environment background. In some embodiments, the method further includes the step of displaying to a user a predicted playback condition comprising at least one of expected latency, frame rate, bandwidth usage, battery usage, decoder compatibility, shader compatibility, or rendering quality.

In some embodiments, the method further includes the step of displaying to a user an environmental placement interface identifying at least one detected surface, focal plane, anchor point, depth region, occlusion boundary, or scale indicator for positioning the holographic media. In some embodiments, rendering the holographic media comprises applying the shader separately to left-eye and right-eye views, or to a plurality of spatial views, to provide transparent stereoscopic or spatial-view playback.

In some embodiments, an artificial intelligence model generates or modifies at least one of a segmentation mask, alpha mask, depth map, pose estimate, occlusion map, missing view, interpolation frame, or super-resolution frame for the holographic media.

### BRIEF DESCRIPTION OF THE DRAWINGS

The disclosure is illustrated by way of example and not limitation in the accompanying drawings, in which like references may indicate similar elements, and in which:

FIG. 1 is a diagram depicting an exemplary system according to aspects of the disclosure;

FIG. 2 is a diagram depicting selection and use of focal planes for overlaying a stream subject from a produced video onto a presentation background according to aspects of the disclosure;

FIG. 3 is an illustration depicting a segmented stream subject rendered in a room of a user's house relative to focal planes and foreground objects according to aspects of the disclosure;

FIG. 4 is an illustration depicting projection of a video presentation or virtual television display into an outdoor presentation background according to aspects of the disclosure;

FIG. 5 is an illustration depicting segmentation of a stream subject from an initial video background according to aspects of the disclosure;

FIG. 6 is an illustration depicting presentation of a segmented stream subject on a different presentation background according to aspects of the disclosure;

FIG. 7 is an illustration depicting a remote meeting or remote demonstration embodiment in which a stream subject is presented in a user environment according to aspects of the disclosure;

FIG. 8A is an illustration depicting stream subjects rendered relative to focal planes in a presentation environment according to aspects of the disclosure;

FIG. 8B is an illustration depicting a changed viewing perspective of the stream subjects of FIG. 8A as a viewer moves relative to the presentation environment according to aspects of the disclosure;

FIG. 8C is an illustration depicting resized stream subjects of FIG. 8A rendered with a virtual background element in a presentation environment according to aspects of the disclosure;

FIG. 9 is a diagram depicting an exemplary computer processing system for implementing aspects of the disclosure;

FIG. 10 is a diagram depicting capture of stereoscopic three-dimensional video using dual cameras and frame-by-frame segmentation according to aspects of the disclosure;

FIG. 11 is a diagram depicting live three-dimensional video capture, background replacement, and rendering to an augmented reality (AR), virtual reality (VR), extended reality (XR), and/or mixed reality (MR) presentation device according to aspects of the disclosure;

FIG. 12 is an illustration depicting monoscopic AI-generated video of a subject on a transparent background according to aspects of the disclosure;

FIG. 13 is an illustration depicting monoscopic AI-generated video of a subject on a green-screen background according to aspects of the disclosure;

FIG. 14 is an illustration depicting stereoscopic or spatial multi-view AI-generated video of a subject on a green-screen background according to aspects of the disclosure;

FIG. 15 is an illustration depicting another monoscopic AI-generated video of a subject on a green-screen background according to aspects of the disclosure;

FIG. 16 is a diagram depicting an alpha-channel two-dimensional shader workflow according to aspects of the disclosure;

FIG. 17 is a diagram depicting an alpha-channel three-dimensional shader workflow according to aspects of the disclosure;

FIG. 18 is a diagram depicting a chroma-key two-dimensional shader workflow according to aspects of the disclosure;

FIG. 19 is a diagram depicting a chroma-key three-dimensional shader workflow according to aspects of the disclosure;

FIG. 20A is a diagram depicting a first portion of a real-time chroma-key two-dimensional shader workflow according to aspects of the disclosure;

FIG. 20B is a diagram depicting a second portion of the real-time chroma-key two-dimensional shader workflow of FIG. 20A according to aspects of the disclosure;

FIG. 21A is a diagram depicting a first portion of a real-time chroma-key three-dimensional shader workflow according to aspects of the disclosure; and

FIG. 21B is a diagram depicting a second portion of the real-time chroma-key three-dimensional shader workflow of FIG. 21A according to aspects of the disclosure.

### DETAILED DESCRIPTION

The figures and descriptions provided herein may have been simplified to illustrate aspects that are relevant for a clear understanding of the herein described devices, systems, and methods, while eliminating, for the purpose of clarity, other aspects that may be found in typical similar devices, systems, and methods. Those of ordinary skill may recognize that other elements and/or operations may be desirable and/or necessary to implement the devices, systems, and methods described herein. But because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

The terminology used herein is for the purpose of describing particular example embodiments only and is not intended to be limiting. For example, as used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc., may be used herein to describe various elements, components, regions, layers and/or sections, these elements, components, regions, layers and/or sections should not be limited by these terms. These terms may be only used to distinguish one element, component, region, layer or section from another element, component, region, layer or section. That is, terms such as “first,” “second,” and other numerical terms, when used herein, do not imply a sequence or order unless clearly indicated by the context. Thus, a first element, component, region, layer or section discussed below could be termed a second element, component, region, layer or section without departing from the teachings of the exemplary embodiments.

Processor-implemented modules, systems and methods of use are disclosed herein that may provide access to and transformation of a plurality of types of digital content, including but not limited to video, image, text, audio, metadata, algorithms, interactive and document content, and which track, deliver, manipulate, transform, transceive and report the accessed content. Described embodiments of these modules, systems and methods are intended to be exemplary and not limiting. As such, it is contemplated that the herein described systems and methods may be adapted and may be extended to provide enhancements and/or additions to the exemplary modules, systems and methods described. The disclosure is thus intended to include all such extensions.

The embodiments provide augmented reality (AR) presence capabilities, in which humans, objects, existing media content, and living creatures may be live streamed across multiple hardware platforms independently from a background (of either the produced content data or of the presentation environment). That is, a background content data feed may be provided across multiple platforms separately from the “stream subject” content, or no background content may be provided to an AR hardware platform; rather, the stream subject may be provided on the hardware platform as a two- or three-dimensional “presence” within the three-dimensional real-time background environmental setting in which the user finds the presence disassociated from the content production background.

The embodiments may provide “presence” utilizing various algorithmic techniques that remove the background in which the stream subject is actually presented, and by rendering the stream subject to an AR device, i.e., virtual reality (VR) glasses or a cellphone, separately from the presentation of a background on that device. That is, the background in which the stream subject is presented may be provided separately from the stream subject, or may be the user's actual background in the actual world at the local site. The aforementioned algorithms may be based principally in assessment of various focal planes, both in the production and in the presentation environments, as discussed below.

More specifically, the aforementioned techniques may include a chroma key disassociation of the stream subject from the stream subject background, or a live segmentation of the stream subject, in which the stream subject is segmented from a data feed in real-time for presentation on the user's AR device. The latter live segmentation methodology may include machine learning that progressively enables the segmentation of stream subjects from existing backgrounds in a variety of background and data set (i.e., theatrical movies, live sports, etc.) settings.

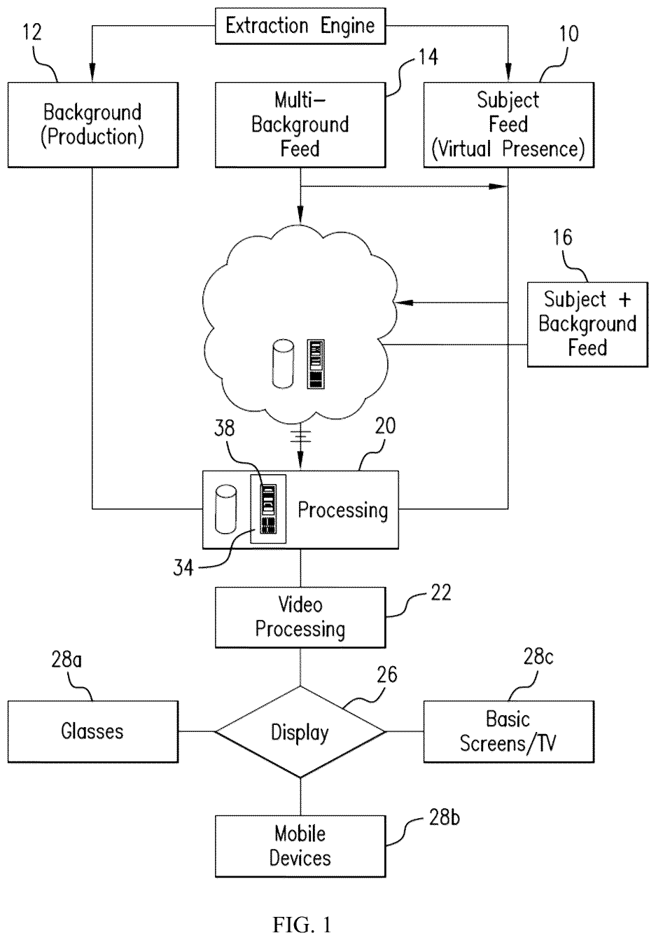

FIG. 1 illustrates an exemplary embodiment of the disclosure. As illustrated, the embodiments may be thick or thin client, that is, the data feeds referenced throughout may be processed off-device for streaming and display on-device, or may be completely or partially processed on-device for presentation on-device.

As shown, at least four data feeds 10, 12, 14, 16, or streams, may be provided to the disclosed processing. This data may include, by way of example, the actual background in which the presentation device resides 12, a background data feed for presentation on the device 14, a stream subject data feed for presentation on the device 10, and/or a data feed in which the subject and a background are integrated when provided to the processing 16. Upon receipt of one or more of these distinct data feeds (noting that the current background may be actual, but is nevertheless herein referenced as a “data feed”), the base processing 20 may perform numerous of the algorithms described herein. That is, the base processing 20 may assess focal lengths and/or focal planes, may assess colors, such as for removal or blocking of those colors, may assess the characteristics of the stream subject to allow for tracking of that subject for segmentation from a feed, and the like.

As is further illustrated in FIG. 1, following performance of base processing 20, video processing 22 for presentation on a device may be performed by at least one video processor 22. That is, video processing 22 may be used to create the full presentation provided to the displaying device, and/or may modify or vary the video presentation/display 26 as needed based upon the operating platform of the presenting device such as AR glasses 28a, mobile devices 28b, basic screens/tv 28c, and so on. Upon completion of the video processing, the presence presentation may be made on the subject AR device. Such AR devices may include, by way of non-limiting example, VR glasses or goggles, AR glasses or goggles, extended reality (XR) glasses or goggles, mixed reality (MR) glasses or goggles, basic video screens, such as televisions or computer screens, and/or mobile devices, by way of non-limiting example.

By way of example, in the event a user wishes to watch a soccer game played in Manchester, England in his front yard, the players, soccer ball, goals, and/or lined playing field might be overlaid in the user's front yard as viewed by the user through VR glasses. Additionally and alternatively, the entire stadium may also be displayed, such as in a movie theater screen format, in the user's front yard on the VR glasses.

Similarly and also by way of nonlimiting example, a user might wish to purchase a large-screen TV, and to do so might hold her mobile device camera up into the corner of her living room where she wishes the television to be placed. The television, which is not actually present, may then be presented at its actual size and in its prospective location in her living room on her mobile device's camera display.

As referenced above, a chroma key technology may be applied to any presentation data feed received in the embodiment of FIG. 1 by the base processing, such as in order to remove any aspect of the received data feed. More particularly, and by way of nonlimiting example, Example 1 of the Experimental Example section below provides an illustrative code excerpt that may be employed to remove any color or colors from a video stream in real-time.

In the known art, a disassociated subject of a video may be provided through the use of a “green screen”. The base processing provided herein, such as the illustrative code excerpt provided in Example 1 below, allows for the providing of a virtual, rather than an actual, green screen, and hence are much more efficient and require substantially less equipment than does the known art. That is, as a feed is received or rendered, any color or colors, shapes, focal plane locations, focal points, or the like, may be removed from the video as it is rendered to and by the processing.

In a secondary embodiment referenced solely by way of nonlimiting example, the base processing (or the video processing) may live segment a received data feed to extract the desired stream subject for presentation on the device referenced in FIG. 1. Of note, the video feed subjected to such live segmentation may be either prerecorded or a live stream.

More specifically, machine learning 34 within processing 20 may be employed in application to multiple different types of videos in order to detect various desired stream subjects, to the extent those data feeds 10, 12, 14, 16 don't already delineate the stream subject from the stream background. Machine learning 34 may include a base coding that is then applied to relevant data sets in order to “learn” how to detect items, backgrounds, and focal planes in moving pictures. For example, a cloud and/or batch process may be triggered to create and educate prospective models based on stored videos, and such as in formats ready for use on iOS, Android, standard, and any other devices.

Thereafter, code or images may be hierarchically categorized by processing 20, such as into a limited number of available categories such as background, focal planes, moving stream subjects, stationary screen subjects, and so on. Thereby, the disclosed subject recognition models 34 may engage in more refined processing, such as processing a stream subject to a particular format or a particular display definition.

By way of further example in the execution, after generating enough images in each product to create a viable product-specific object recognition model, a training algorithm may be run to create, for example, both a CoreML (iPhone) and Python compatible model. The Python compatible model may then be used primarily for testing against previous iterations to determine how to proceed with generating new models.

Simply put, a preliminary set of detection rules may be provided to the disclosed processing. These preliminary detection rules would include, by way of example, coding related to and indicative of particular characteristics of a desired stream subject. By way of nonlimiting example, for a human stream subject such characteristics might include ranges on typical human heights, widths, color variations, rates of motion (such as may vary as between different sporting events and theatrical movies, by way of example), and the like.

These preliminary rules may then be applied to a predetermined plurality of subject videos in order that the machine learning may improve its stream subject segmentation capabilities. Once these segmentation capabilities reach a predetermined statistical success threshold, the segmentation rule set may “go live”. However, in particular embodiments, a feedback path may be provided to a live run that enables a continuous machine learning to continually improve the applied rules based on coded device feedback, user feedback, administrator feedback, advertiser feedback, or the like.

Accordingly, the embodiments enable extraction of a stream subject in a video for presentation of at least that stream subject, embedded with or distinct from the stream subject's original background, on an AR or a standard device. As such, the foregoing methodologies remedy the substantial impracticality of known green screen methods. They further allow for separation of the background from the stream subject, such that the background may also be distinctly used/rendered from the stream subject in the system provided in FIG. 1, by way of example.

It will be apparent to the skilled artisan, in light of the discussion herein, the manner of execution of the disclosed embodiments. By way of example, the initial parameters referenced for machine learning may be provided based on the presentation source, the receiving user, and so on. By way of example, a content provider may indicate what that content provider wishes to be segmented out from its initial background, and/or what aspects of an initial background or stream subject the content provider wishes to be included in the ultimately displayed video. For example, a content provider selling television sets that wishes a user to be able to present those television sets in her own living room may indicate that the television set and the television set alone is to be segmented from the content provided by the content provider. However, Major League Baseball may indicate that they wish, for a center field viewing data feed, that the umpire, the catcher, the batter, the bat, home plate, the pitcher, the ball, the pitcher's mound, and second base be segmented from its data feed, such that all of those aspects of a baseball game may be presented to a viewing user on a display device using the background of that user's actual environment.

In light of the foregoing, the ability to segment certain stream subjects may be a result of the quality of the data feed received. That is, a golf ball in flight may be a relatively small number of pixels in a video feed on a frame by frame analysis basis of that video feed, and, as such, the capability to extract that golf ball from its base video feed may be at least partially dependent on the quality of the video feed received. In short, and as will be appreciated by the skilled artisan, the higher the resolution of a provided video feed, the lower the pixilation from that feed will be, and the more simplistic will be the segmentation of smaller discrete aspects from that base video feed.

Additionally, the video quality also allows improved association of a segmented stream subject with an actual background or a separate background feed. Simply put, a higher quality video feed, such as a 4K video feed, presents more refined pixels, and more numerous pixels than a lower quality video feed, such as a 2K video feed. Consequently, the pixilation of a segmented stream subject, including particularly at the edges of the extracted stream subject, may be more negligible in a higher quality video than a lower quality video upon segmentation of the stream subject, and placement of that stream subject into the desired background display. It goes without saying that, particularly at the edges of an extracted stream subject presented to the user, the video processing referenced in FIG. 1 may include smoothing techniques that allow for deblurring, edge smoothing, color correction, and debarring and demissed colorization, particularly at the edges of the presentation of the stream subject.

Moreover, presentation of videos of different types may likewise be dependent upon the quality of an underlying video feed. By way of example, underlying video of high resolution may allow for presentation of a segmented stream subject using three-dimensional effects. Of course, such 3D effects are highly dependent on the algorithmic focal plane analysis performed by the processing and discussed herein below.

More particularly, and in an exemplary embodiment, a live video stream may be processed by the disclosed processing 20 in FIG. 1 on a frame by frame basis. Each frame may be analyzed based on a series of focal planes and/or multi-point focal points within the stream, such as with particularity relative to the desired stream subject. Accordingly, once the stream subject is segmented from the body of the video stream, the frame by frame focal plane analysis enables an overlay onto focal planes and/or multi-point focal points of any background.

Thereby, the background onto which the segmented stream subject is to be overlaid, such as a background of a room having walls viewed through VR glasses, may include a similar focal plane analysis of the presentation background. Needless to say, a focal plane overlay allows for background objects in the foreground of a presentation to be placed in front of a displayed stream subject, and background objects that should be presented behind the stream subject to be displayed properly behind the stream subject.

Needless to say, a weighting algorithm 38 may also be employed in circumstances where background focal planes in the ultimate presentation to a user are of substantially different distances, i.e., are much closer or much farther away, than the available focal planes in the initial background from which the stream subject was taken, which initial background was initially subjected to a focal plane analysis. That is, a multi-point, multi-planar analysis 38 of both a produced content background and an ultimate presentation may cause the focal planes in the ultimate presentation to receive a progressively increasing weight of actual distance (to account for perspective) of 7× in the foreground, 4.5× in the midground, and 3.2× in the background as compared to the same respective background planes in the produced content. Of course, this allows for the stream subjects to be presented on a much different background, such as wherein a professional soccer game is presented in a small living room, without distortion of the proper size or sizes of the stream subjects presented in the differing backgrounds as between the presentation environment and the content production environment.

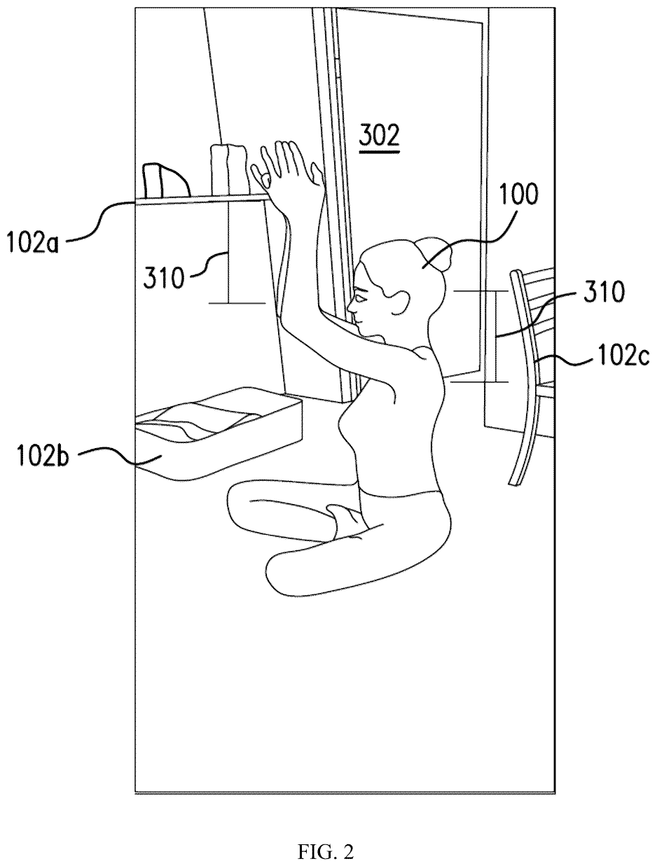

Moreover, and as referenced above, and shown throughout FIGS. 2 through 8, the embodiments thereby enable, for example, a person 100 walking in a theatrical release to walk across a user's living room, and be presented as walking on the user's living room floor (rather than floating in the air), and similarly walking behind the user's coffee table in the foreground of the viewed display (based on the viewer's distance from the character walking), such that the theatrical subject's feet disappear behind the coffee table, based on a focal plane 102 presented by the actual coffee table in the user's living room (i.e., the actual background). Similarly, the focal plane analysis 38 allows for the maintenance of proper relative sizes of the stream subject 100 in relation to the viewer from any focal plane 102 in the background of the user's field of view. That is, “life-sized” stream subject 100 content may be properly estimated and readily rendered into an actual environment background based on an overlay of the available focal planes 102a, 102b, 102c, . . . in each setting, i.e., in the initial content production setting from which the stream subject was segmented, and in the ultimate presentation setting, in which the new background may be the user's living room, for example.

FIG. 2 illustrates the selection of focal planes 102a, 102b, 102c, . . . in a produced video to be segmented into an ultimate presentation background 302. Of note, the presentation background 302 may be, for example, a real world setting such as may be viewed through VR glasses, or may be a background selected from a different media, such as a video different from the one which the segmented stream subject is taken.

As illustrated, any flat surface within a view field, such as within the view field of a mobile device, or VR glasses, presents at least one potential plane 102a, 102b, . . . from which to assess a focal plane overlay 310. By way of example, in a professional soccer game the goal may present a focal plane, as may an advertisement placed on a stadium wall behind the goal; and in a living room, a table, chairback, floor, ceiling, or lampshade may likewise serve as a focal plane.

Consequently, subject to the assessment of one or more focal planes 102a, 102b, . . . suitable to engage in the disclosed overlay 310, a stream subject 100 or subjects may be placed anywhere at any distance onto or in association with a plane or focal point 102a, 102b, . . . in the presentation display 26 referenced in FIG. 1. That is, the stream subject 100 may be placed anywhere relative to any 3D plane in a background of the presentation display.

As may be appreciated, relative distances as between a background and a user may be manually or automatically selected in the embodiments. For example, a user may tap an area in a cell phone camera view at which a stream subject is to be displayed, and/or may elect for the stream subject to be life-size, or “stadium size” (i.e., a soccer player of a similar size to that the user would view if the user were in stadium seating in a stadium watching a soccer game). The processing of the embodiments performs this by assessing flat or substantially flat surfaces within each of the original production presentation and the user presentation backgrounds, and maintains that plane or those planes as a reference to allow for the selected presentation of the stream subject. Not only does this allow for manual selection of a presentation, but also allows for a maintenance of perspective of the presentation—that is, as a viewer may walk closer to or away from a stream subject, the perspective and sizing of the stream subject may variably change dependent upon the presentation. In the foregoing example, a life-size soccer player might have a perceptible change in size as a user walked from 25 feet away from that soccer player to three feet away from that soccer player. However, in a stadium view setting, the user walking 25 feet closer to the soccer player stream subject would have very little effect on the presented size of the soccer player stream subject.

Moreover, and as referenced above, the user may change perspective of the stream subject as the user moves about. Thereby, the disclosed processing and/or video processing may engage in an analysis of multiple views of the stream subject throughout the base video, such that the processing can extrapolate the appearance of the stream subject from different angles, or the processing may simply take each frame by frame flat view and extrapolate that view into an appearance from multiple angles.

Yet further, a subject may be produced in 3D to enable a multi-perspective presence view, whether or not the initial production was formally in 3D. For example, 3D cameras 1510 may capture a stereo video with the subject in any environment. Using segmentation aspect 1512, the subject may then be removed frame by frame from the production environment, and the production environment replaced with a digital green screen.

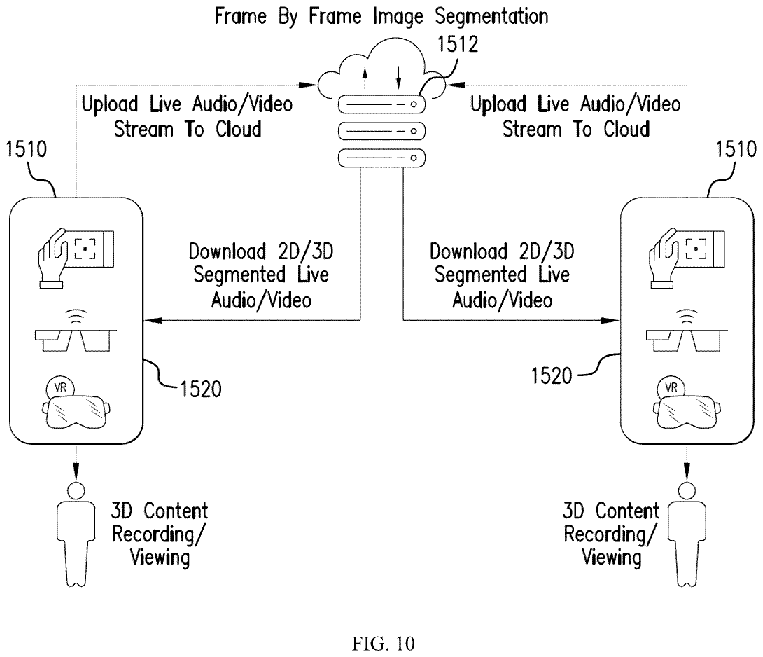

Alternatively, using two cameras 1510, such as the two back cameras of a smartphone, a “stereo” 3D video may be created with the subject in any environment. As above, using segmentation 1512 the subject may be removed frame by frame from the production environment, such as via a virtual/digital green screen. This is illustrated in the embodiment of FIG. 10.

The frame by frame processing for 3D may use two different strategies. The first may use a convolutional neural network to detect the subject in each frame, and to then remove the background from the video around the subject, frame by frame (semantic segmentation at the pixel level). This technique may be trained by using a dataset of images with persons shown therein; following detection of the person, a filter is applied replacing with a green pixel all pixels not corresponding to the person.

The second method may use the 3D cameras or smart phones with dual cameras and other sensors to combine both recordings to allow for calculation of the relative distance of objects by creating a depth map for each video frame, i.e., through the use of the focal plane analysis discussed throughout. In this method, a mask is created for each video frame, and each pixel will or will not be filtered depending on the corresponding mask. Pixels that don't correspond to the mask will be replaced with a green pixel.

Upon receipt at presentation device 1520, the green background may be removed frame by frame, such as with a live chroma key, in real time, at runtime. In order to achieve this, a shader may be employed, such as based on the ultimate presentation device. Shaders may remove the green background and replace it with a transparent background. This may be accomplished by: receiving a key color to extract from the image; receiving a threshold for the color to be removed from the video (the higher the value, the more colored pixels are considered in the chroma-keying); and by receiving a slope, which smooths the threshold to soften the effect of the color removal. Additionally, and alternatively, the shader may operate for a VR/AR headset to either: create a new frame for each camera by cropping the bottom and top parts from the video stream and delivering it to the left and right screens; or create a new frame for each camera by cropping the left and right parts from the video stream and delivering it to the left and right screens.

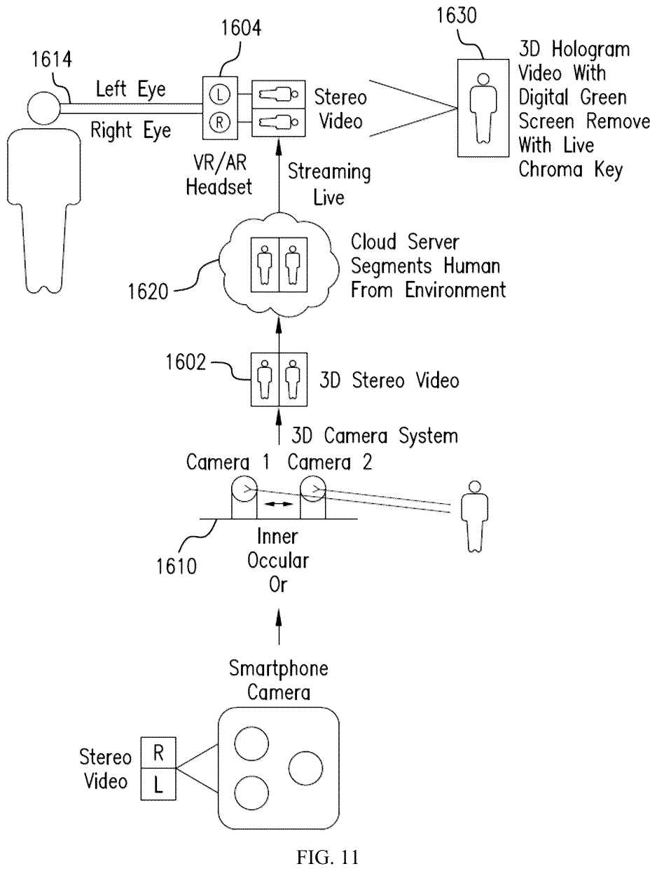

FIG. 11 illustrates that a 3D live video feed is recorded or streamed in real time 1602 into an AR/VR/XR/MR headset or other presentation device 1604. By projecting two camera feeds 1610 from, for example, a 3D camera system into the left and right “eye” 1614 of the VR/AR headset, different content is delivered to each eye thus creating a 3D hologram 1630. Additionally, a machine learning technique is applied to the video stream by removing each frame of background from the subject 1620, and replacing the background environment with, for example, a digital green screen. The final 3D stereo video (over/under or left/right) is run to remove the digital green screen, leaving only a three dimensional human being, animal or object for presentation 1614. Both live broadcasts and previously recorded videos can be thus consumed and rendered. Apart from 3D videos, 2D videos can also be captured and delivered for presentation 1614.

Thus, in accordance with the foregoing, a user may be enabled to manually choose between different displays and/or modes, such as in a provided “app”. By way of example, a user might select “television mode”, or might select “live mode”, for a sporting event. If live mode were selected, the background of the soccer match base video might be segmented out, and only the players, the ball, and the goals presented to the user. On the contrary, if TV mode were selected, a movie theater size television screen might be presented on a background, such as in a user's backyard, wherein the entire soccer match, including the actual soccer match background in the base video, is presented on a “floating” movie screen. Of course, it will be apparent to the skilled artisan that, although the prior disclosure is made with regard to manual selection by an ultimate viewer, the disclosed processing may be capable of automatically selecting such choices, or maintaining user preferences from prior manual selections, by way of example.

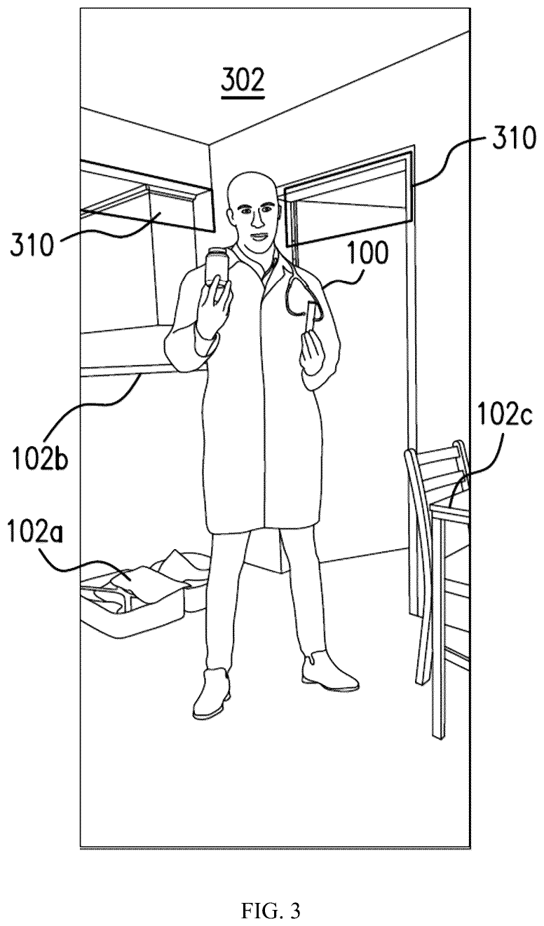

FIG. 3 illustrates an application of the disclosed embodiments. In the illustration, a stream subject 100 is removed from its initial base video/background, and is presented in a room of a user's house as if the stream subject 100 is in the room. The illustrated presentation may be made, by way of example, on VR glasses. Of note, it appears that the stream subject's feet are in contact with the floor of the user's house, and that objects in the foreground of the presentation, such as a coffee table, provide focal planes/points 102 that will allow for a complete or partial blocking of the stream subject's 100 lower extremities as if the stream subject were standing in the house.

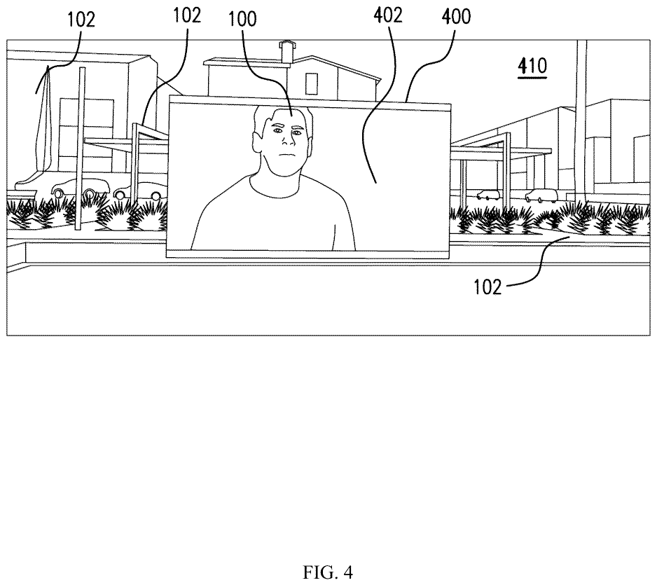

FIG. 4 illustrates the projection of a full television set 400 into a background of a yard 410. In the illustration, both the segmented subjects 100 and the base video background 402 are presented together on a faux background of a television set 400 based on focal planes 102 presented in a user's yard.

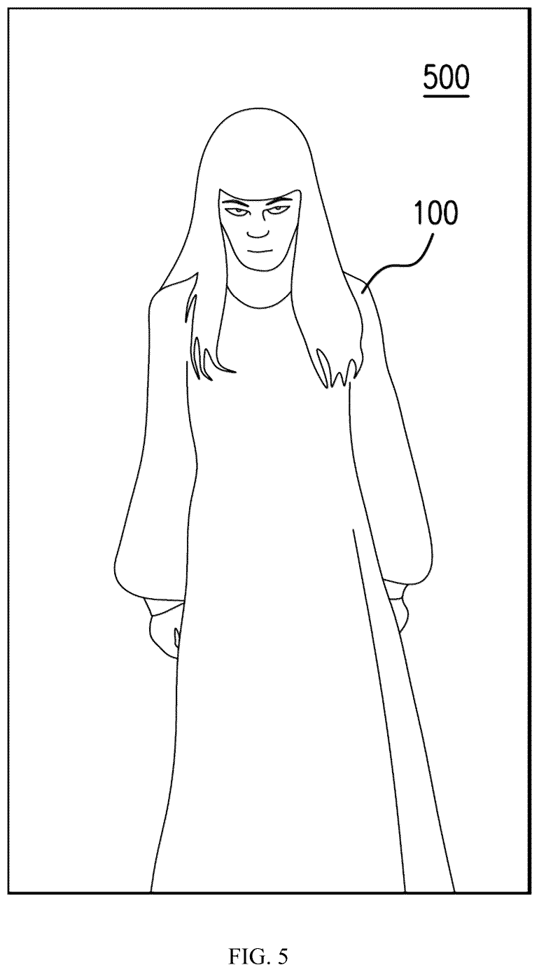

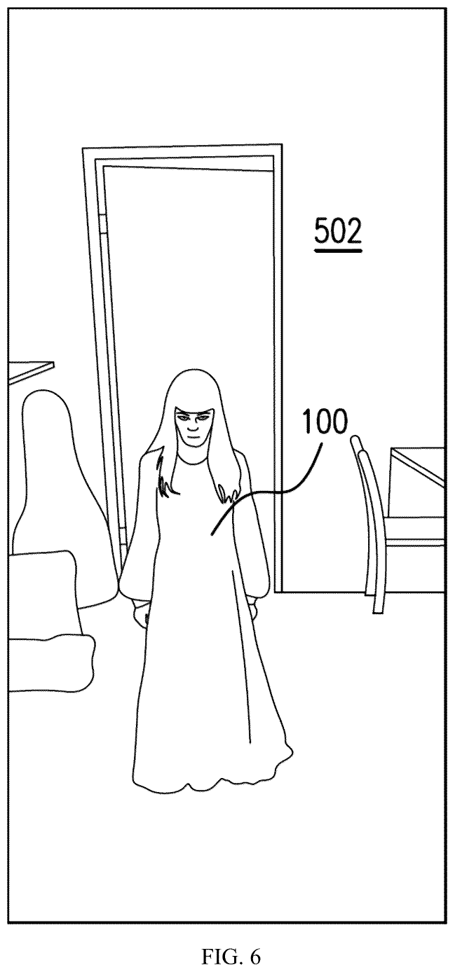

FIGS. 5 and 6 illustrate the removal of a stream subject 100 from a background 500 in an underlying base video (in this case, a theatrically released movie on a DVD) for inclusion in a presentation to a user on a different background 502. As illustrated, the stream subject 100 is segmented from the base video using a focal plane analysis, and overlaid into a room of a user's house based on focal plane analysis of the background presented by the room.

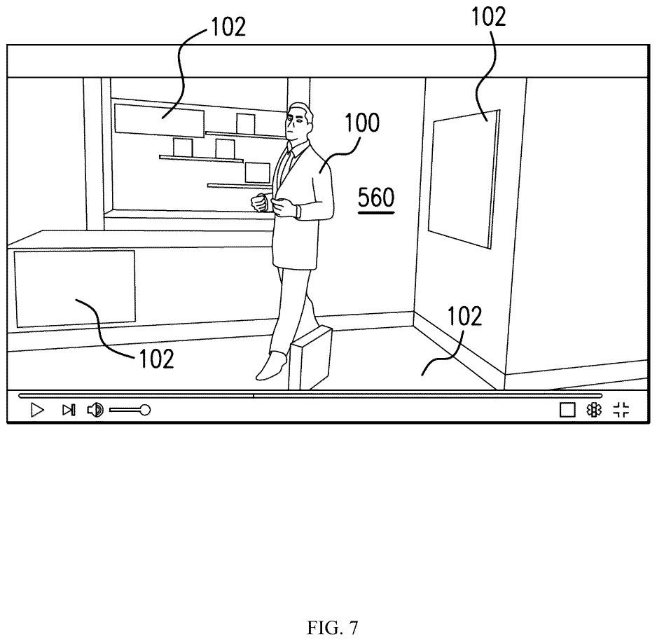

Various particular applications may be uniquely provided via the embodiments. For example, FIG. 7 illustrates a remote business meeting embodiment. Whether down the street, or across the country, the illustrated subject 100 is effectively presented on the background of the user's living room 560. The subject can show and illustrate everything he wishes, and the user can see the illustration from various angles and in 3D. As such, this embodiment is ideal, for example, for remote marketing demonstrations.

By way of further example, a teledoc appointment may provide a bi-directional, focal plane 102 based 3D presentation of the stream subject to both end users. That is, the patient user may see the doctor 100 in her living room 560, while the doctor may see the patient in her office. Of course, a 3D view of the patient allows the doctor to move around and diagnose the patient remotely in a manner heretofore unknown. This, of course, will allow doctors to treat patients in ways not presently possible, including those patients unable to get to the doctor or to the ER.

Accordingly, the embodiments allow nearly limitless applications. For example, scientific and engineering discussions may be had in which one party is on-site, such as in a laboratory, and another party sees the first party, and parts, chemicals, or the like manipulated by the first party, in the other party's garage, in three dimensions, such as from thousands of miles away. Moreover, the ability to enhance size allows the remote party to “zoom in” and see particular aspects with great specificity, for example.

Similarly, calls with family may now be truly live, in-person, and in three dimensions, such that all parties appear to be truly “present” together. During certain occurrences, such as during a pandemic, this may be the only way that families and friends can truly gather.

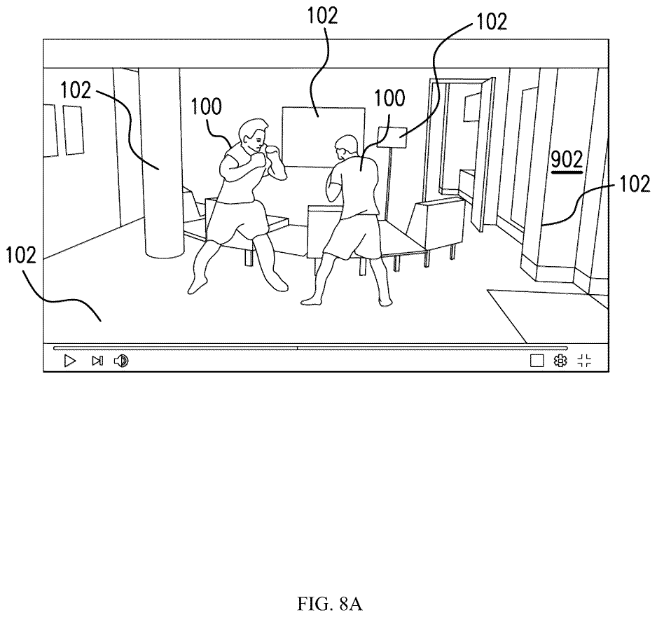

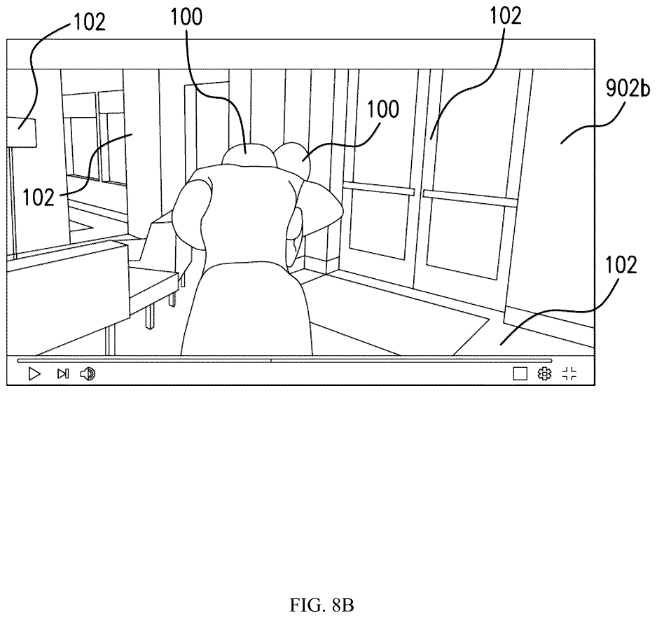

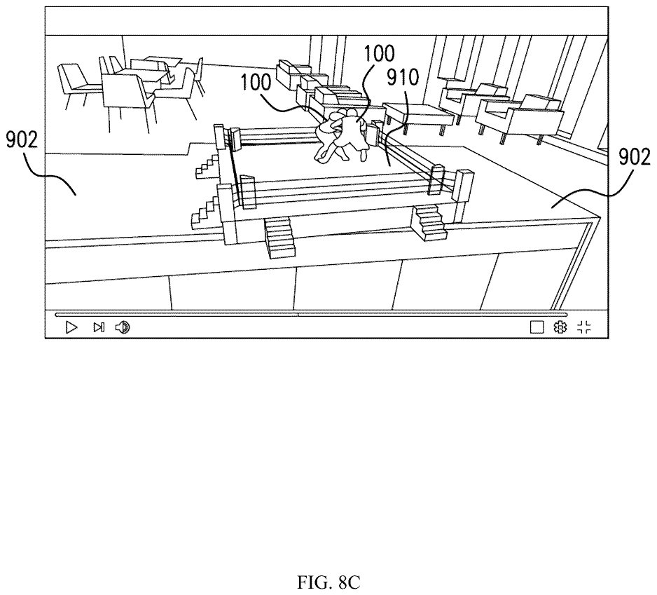

FIGS. 8A-8C illustrate a pair of fighters as stream subjects 100. These stream subjects are not only shown displayed on the background 902 of a hotel lobby, but additionally are shown using the aforementioned three dimensional estimation and multi-camera visual data from the production site.

Accordingly, the stream subjects are automatically “life-sized” as compared to the focal planes 102 assessed in the initial background 902 in FIG. 8A. Thereafter, the user may walk around the fighters 100, to the extent they are “locked” to their focal location in the hotel lobby, and the angles of the fighters will be viewed as three dimensional, against the varying background 902b as the viewer moves about the lobby, as illustrated in FIG. 8B. Finally, the fighters 100 are re-sized, and placed within a virtual “ring” as a primary background 910, to allow for presentation of the fight on a table in the lobby, acting as the presentation background 902, as shown in FIG. 8C.

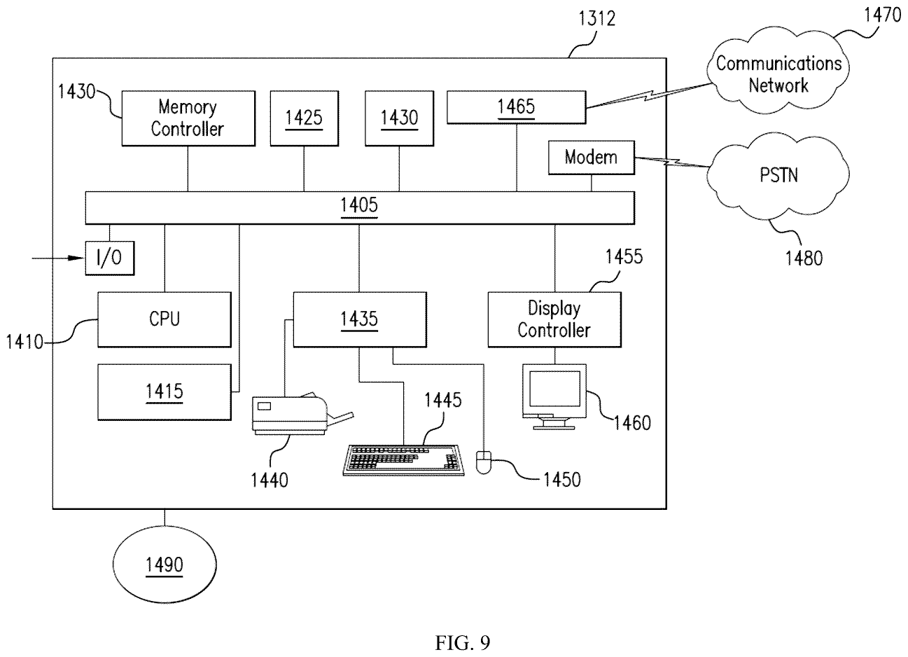

FIG. 9 depicts an exemplary computer processing system 1312 for use in association with the embodiments, by way of non-limiting example. Processing system 1312 is capable of executing software, such as an operating system (OS), applications, user interface, and/or one or more other computing algorithms/applications 1490, such as the recipes, models, programs and subprograms discussed herein. The operation of exemplary processing system 1312 is controlled primarily by these computer readable instructions/code 1490, such as instructions stored in a computer readable storage medium, such as hard disk drive (HDD) 1415, optical disk (not shown) such as a CD or DVD, solid state drive (not shown) such as a USB “thumb drive,” or the like. Such instructions may be executed within central processing unit (CPU) 1410 to cause system 1312 to perform the disclosed operations, comparisons and calculations. In many known computer servers, workstations, personal computers, and the like, CPU 1410 is implemented in an integrated circuit called a processor.

It is appreciated that, although exemplary processing system 1312 is shown to comprise a single CPU 1410, such description is merely illustrative, as processing system 1312 may comprise a plurality of CPUs 1410. Additionally, system 1312 may exploit the resources of remote CPUs (not shown) through communications network 1470 or some other data communications means 1480, and/or local CPUs, as discussed throughout.

In operation, CPU 1410 fetches, decodes, and executes instructions from a computer readable storage medium, such as HDD 1415. Such instructions may be included in software 1490. Information, such as computer instructions and other computer readable data, is transferred between components of system 1312 via the system's main data-transfer path. The main data-transfer path may use a system bus architecture 1405, although other computer architectures (not shown) can be used.

Memory devices coupled to system bus 1405 may include random access memory (RAM) 1425 and/or read only memory (ROM) 1430, by way of example. Such memories include circuitry that allows information to be stored and retrieved. ROMs 1430 generally contain stored data that cannot be modified. Data stored in RAM 1425 can be read or changed by CPU 1410 or other hardware devices. Access to RAM 1425 and/or ROM 1430 may be controlled by memory controller 1420.

In addition, processing system 1312 may contain peripheral communications controller and bus 1435, which is responsible for communicating instructions from CPU 1410 to, and/or receiving data from, peripherals, such as peripherals 1440, 1445, and 1450, which may include printers, keyboards, and/or the operator interaction elements on a mobile device as discussed herein throughout. An example of a peripheral bus is the Peripheral Component Interconnect (PCI) bus that is well known in the pertinent art.

Operator display 1460, which is controlled by display controller 1455, may be used to display visual output and/or presentation data generated by or at the request of processing system 1312, such as responsive to operation of the aforementioned computing programs/applications 1490. Such visual output may include text, graphics, animated graphics, and/or video, for example. Display 1460 may be implemented with a CRT-based video display, an LCD or LED-based display, a gas plasma-based flat-panel display, a touch-panel display, or the like. Display controller 1455 includes electronic components required to generate a video signal that is sent to display 1460.

Further, processing system 1312 may contain network adapter 1465 which may be used to couple to external communication network 1470, which may include or provide access to the Internet, an intranet, an extranet, or the like. Communications network 1470 may provide access for processing system 1312 with means of communicating and transferring software and information electronically. Additionally, communications network 1470 may provide for distributed processing, which involves several computers and the sharing of workloads or cooperative efforts in performing a task, as discussed above. Network adaptor 1465 may communicate to and from network 1470 using any available wired or wireless technologies. Such technologies may include, by way of non-limiting example, cellular, Wi-Fi, Bluetooth, infrared, or the like.

Additional embodiments are described herein. The disclosed embodiments integrate generative video synthesis with automated background isolation and a hardware-accelerated decoder path, delivering keyed or transparent holograms in sizes suitable for real-time mobile playback.

The embodiments may provide a unified pipeline that (i) programmatically generates photorealistic holographic video and still images with generative-AI models and (ii) renders those assets natively on web browsers, mobile devices, AR glasses, stereoscopic displays and VR head-mounted displays. Elements of the disclosed embodiments include: AI Generated Video Pipeline: The generative AI video pipeline yields people, objects, or scenes composited on solid-colour chroma, arbitrary keyed backgrounds, or full-alpha Video/PNG transparency; Comprehensive Cinematography Controls Lighting, focal length, lens type, depth-of-field, camera motion, and colour grading are parameterized and reproducible; Multi-Format Output: The same generation pass exports 2D, stereoscopic 3D, spatial-video (multi-view), 180°, 360° and video file assets; Real-Time or Offline Paths Assets can be synthesized live for telepresence or mastered for on-demand playback; and GPU Shader Stack Custom shaders remove keyed backgrounds or render alpha-video files and/or streams in hardware, enabling consistent playback across heterogeneous hardware.

This software-centric approach streamlines production, eliminates physical-studio overhead, and delivers ready-to-use holographic assets that play natively on web, mobile, and XR devices.

TABLE 1
Summary table of key disclosure elements

| Aspect | Details |
|---|---|
| Purpose | New workflow for creating holograms (video + images) with generative |
| | AI and new technologies for rendering them on mobile, web, AR |
| | glasses, and VR headsets. |
| Background Options | Solid green screen • Any chroma-keyable color • True |
| | transparency (single PNG frame or alpha-video files). |
| Production Variables | Lighting • Camera position • Framing • Focal length • Lens type • |
| | Aperture • Depth of field • Camera motion • Color grading • Stabilization. |
| Output Formats | 2D video • Stereoscopic video • Spatial-video (multi-view) • 180° |
| | video Immersive video • 360° video • video files (all with green- |
| | screen or transparent backgrounds). |
| Creation Modes | Real-time generation for live use • Post-production for pre- |
| | recorded holograms. |
| Rendering Technology | Custom shaders remove chroma-key backdrops and decode video files |
| | with alpha transparency. |
| Target Platforms | Web (desktop & mobile), native mobile apps, cross-platform |
| | frameworks, AR headsets, VR headsets, AR glasses. |
| Cost Impact | Capture and post-production expenses drop by roughly an order of |
| | magnitude compared with traditional green-screen studio shoots, |
| | widening access to holographic content for training, e-commerce, live |
| | events, and remote collaboration. |

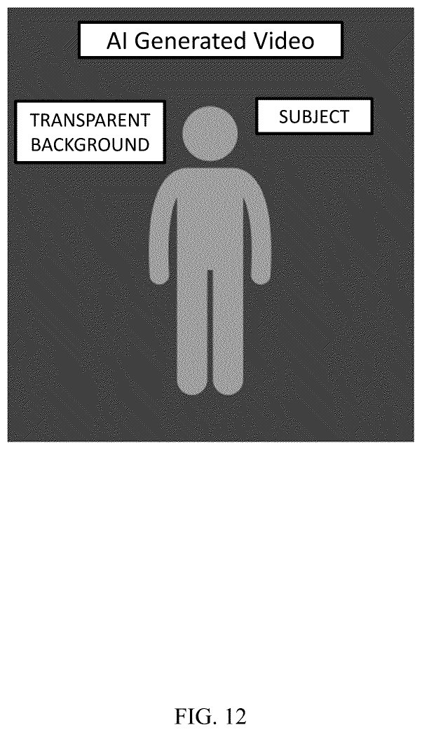

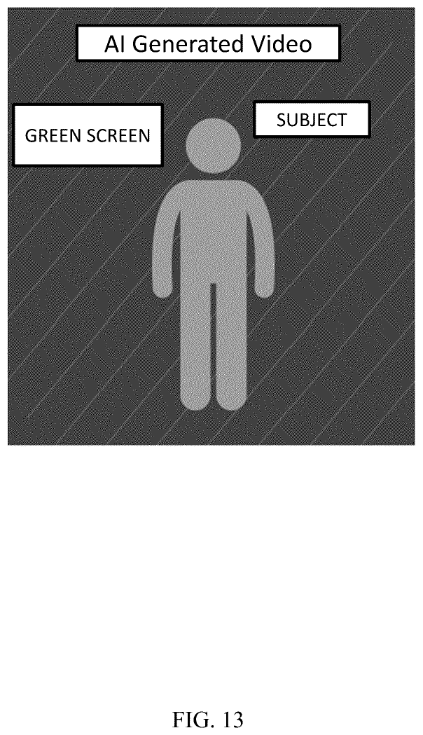

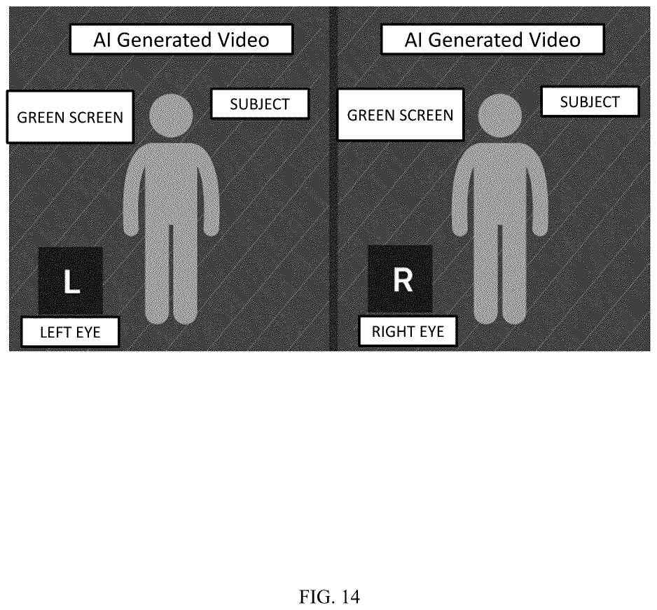

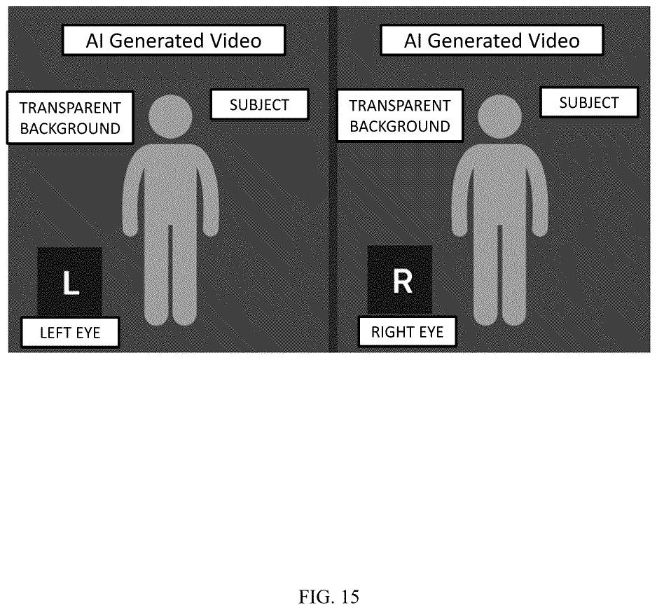

FIG. 12 depicts a monoscopic AI generated video of a subject on a transparent background. FIG. 13 depicts a monoscopic AI generated video of a subject on a green screen. FIG. 14 depicts a stereoscopic/Spatial (multi-view) AI generated video of a subject on a green screen. FIG. 15 depicts a monoscopic AI generated video of a subject on green screen.

Limits of the Conventional Green-Screen Studio Workflow: Production teams still rely on traditional green-screen studios to create composited video of subjects onto different backgrounds. This approach faces four persistent obstacles: 1. High On-Set Overhead Large physical sets, uniform chroma backdrops, calibrated lighting grids, camera rigs, and crew all drive up hourly costs. Scheduling talent and studio time further inflates budgets-often beyond the reach of smaller enterprises or rapid-iteration projects. 2. Labor-Intensive Post-Production Manual keying, edge cleanup, spill suppression, rotoscoping, and colour correction demand specialised artists and lengthy render times. Each revision or alternate background triggers another round of compositing and quality control. 3. Limited Flexibility and Re-usability A new scene, camera angle, or aspect ratio usually means a reshoot. Delivering the same performance in 2D, stereoscopic, spatial-video (multi-view), 180°, and 360° formats requires multiple setups or extensive conversion work, delaying distribution. 4. Distribution Constraints High-resolution chroma-key footage remains bandwidth-heavy, while mobile browsers and lightweight XR devices often struggle with real-time decoding and playback consistency. These constraints restrict green-screen holographic content to high-budget productions, leaving education, e-commerce, training, and live events without a scalable, cost-effective pipeline.

TABLE 2
Comparison of embodiments of the disclosure with a conventional
green-screen studio workflow

| Reference | Approach | Limitation Addressed |
|---|---|---|
| Volumetric Capture Rigs (Microsoft | Multi-camera arrays | Capital-intensive; large file sizes; |
| Mixed Reality Capture, Intel | reconstruct point clouds or | requires specialised playback |
| Studios) | meshes. | engines. |
| Depth-Camera-Based | Real-time depth + RGB | Depth artefacts; bandwidth |
| “Holoportation” (various patents | streaming of people. | intensive; limited to RGB-D |
| 2016-2024) | | hardware. |
| Apple Spatial Video (MHEVC) | Dual-camera stereoscopic | Device-specific capture; does not |
| | recording with alpha channel | cover AI generation or real-time |
| | support. | synthesis. |
| Chroma-Key Video Compositing | Manual shooting on | Requires physical set, lighting |
| (legacy broadcast techniques) | green/blue screen and offline | control, and post-production |
| | keying. | keying. |
| Generative-AI Video Models | Text-to-video synthesis, | No integrated pipeline for keyed |
| (2023-2025) | typically on opaque | or alpha transparency, and no |
| | backgrounds. | hardware decoding strategy. |

In some embodiments, the system is model-agnostic, so any present or future generative-video technique can be integrated without changing the playback code.

TABLE 3
Architectural overview of an embodiment of the disclosure: AI
content-generation pipeline and playback stack

| Sub-Process | Core Functions |
|---|---|
| AI Content Generator | Generative Video Engine—Synthesises people, props, or |
| | scenes while honouring cinematography tokens such |
| | as lighting, lens parameters, motion paths, and colour grading. |
| | Background Selector—outputs the subject on (a) solid |
| | green, (b) a user-defined keyed |
| | colour, or (c) true transparency. |
| | Multi-Format Encoder—writes synchronised 2-D, stereoscopic 3-D, |
| | spatial-video |
| | (multi-view), 180°, and 360° tracks in a single pass. |
| Cross-Platform Playback | Alpha/Chroma Shader—GPU kernel that removes keyed |
| Stack | backdrops or composites alpha video. |
| | Adaptive Decoder—leverages whatever hardware codec pipeline |
| | the host device exposes. |

Key aspects of the disclosure: 1. AI generative video Generates videos of objects and people on both a green screen or transparent video background. 2. Parameterised Cinematography Tokens for Keyed/Transparent Subjects Encodes lighting, lens, depth-of-field, camera motion, and colour grading as structured parameters that the generator applies while producing green-screen or transparent background video footage that includes the subjects (objects, environments or people). 3. Parallel Multi-Format Encoding of Keyed/Transparent Clips Creates 2D, stereoscopic 3-D, spatial-video (multi-view), 180°, 360° and video files of the same green screen or alpha-video background footage of the subjects (objects, environments or people).

4. Modular Shader Suite for Transparent-Video Playback (Offline & Real-Time): Alpha 2-D Renderer—plays alpha-video with all fully transparent pixels discarded, producing a clean, background-free 2-D video in both file playback and streaming modes; Alpha 3-D Renderer—plays background-free alpha-video for left and right eyes (SBS, OU, or spatial multi-view), delivering stereoscopic 3-D video for stored assets and live feeds; Chroma 2-D Renderer—executes single-pass chroma removal on keyed 2-D footage, outputting transparent 2-D video for offline files or real-time streams; and Chroma 3-D Renderer—performs real-time matte extraction on keyed stereoscopic frames (SBS, OU, spatial), likewise supporting pre-rendered assets.

5. Low-Latency Alpha/Chroma Streaming Pipeline for WebRTC: Extends the above shaders to incoming WebRTC frames, supplying 2-D or 3-D composites with sub-50 ms end-to-end latency for live telepresence, while preserving identical behaviour for offline playback.

Dual-Lens Capture-to-Spatial Broadcast Engine: Aligns two handset cameras, merges them into a single stereoscopic or spatial frame in one shader pass, and broadcasts via the WebRTC pipeline—supporting both local offline recording and live 3-D streaming to AR glasses and VR/MR headsets.

The following examples illustrate the breadth of markets that can integrate AI-generated keyed or transparent holograms without traditional green-screen overhead.

TABLE 4
Sample cross-industry use cases

| Sector | Representative Scenario |
|---|---|
| Training & Simulation | On-demand holographic instructors generated via prompt |
| | edits, embedded in learning-management modules. |
| Healthcare & Medical XR | Patient-specific preoperative briefings rendered as |
| | transparent holograms over 3-D anatomical models. |
| Retail & Visual Merchandising | Prompt-generated product mannequins (“red leather jacket |
| | under softbox lighting”) placed in AR try-on widgets for mobile |
| | shoppers. |
| Entertainment & Film Pre-Viz | Directors iterate blocking and lighting with AI-generated stand-ins |
| | on transparent backgrounds, reducing physical green-screen shoot |
| | days. |
| Television Broadcast | Real-time holographic presenters composited over virtual sets, |
| | switched instantly between keyed colour and alpha-video feeds. |
| Holographic Storybooks | Children view interactive story characters that step off the page |
| | as transparent holograms on tablets or lightweight AR glasses. |
| Sports Fan Engagement | Live player introductions or instant-replay moments delivered as on- |
| | field holograms to stadium AR headsets and second-screen apps. |
| Concerts & Live Events | Artists appear simultaneously on stage and as remote holograms |
| | for global audiences, with venue-specific branding keyed behind |
| | them. |
| E-Commerce | Product holograms auto-generated from catalogue text and |
| | displayed in-room at true scale through web or mobile AR. |
| Remote Collaboration | Lightweight telepresence avatars streamed in browsers-no plug-ins |
| | or proprietary capture rigs required. |

Shader Suite for Alpha- and Chroma-Based Transparent Video Playback & Streaming: A family of GPU shaders converts AI-generated video—whether it carries an embedded alpha channel or a keyed (green-screen) background—into instantly compositable output across mobile screens, AR glasses, and VR/MR headsets. Each shader targets a specific dimensional format (2-D, stereoscopic 3-D, or spatial multi-view) and delivery mode (file playback or real-time WebRTC), removing backgrounds or applying alpha in a single pass.

TABLE 5
GPU shader modules for transparent-video playback and live
streaming

| | | | Dimensional | | |
|---|---|---|---|---|---|
| Shader/ | | Delivery | Formats | Key | |
| Module | Input Type | Mode | Supported | Functions | Target Devices |
| Alpha-HEVC | Video file | File | 2-D, Spatial | Single-pass | |
| 2-D Renderer | containing an | playback | (multi-view) | alpha | |
| | alpha | | | compositing | |
| | channel | | | | |
| Alpha-HEVC | Video file | File | SBS, OU, | Applies | AR glasses, VR/MR headsets |
| 3-D Renderer | containing an | playback | Spatial (multi- | alpha mask | |
| | alpha | | view) | per eye; | |
| | channel | | | composites | |
| | | | | left & right | |
| | | | | views | |
| Chroma 2-D | Video file | File | 2-D, Spatial | Live chroma | Phones, tablets, AR glasses, |
| Renderer | with a keyed | playback | (multi-view) | removal for | VR headsets |
| | background | | | transparent | |
| | | | | overlays | |
| Chroma 3-D | Video file | File | SBS, OU, | Real-time | AR glasses, VR/MR headsets |
| Renderer | with a keyed | playback | Spatial (multi- | chroma-key | |
| | background | | view) | removal; | |
| | | | | outputs | |
| | | | | transparent | |
| | | | | stereo | |
| Real-Time | WebRTC | Live | 2-D, Spatial | Live | Phones, tablets, AR glasses, |
| Alpha/Chroma | video stream | playback | (multi-view) | background | VR headsets |
| 2-D Renderer | (alpha or | | | removal; | |
| | keyed) | | | transparent | |
| | | | | 2-D overlay | |
| Real-Time | WebRTC | Live | SBS, OU, | On-the-fly | AR glasses, VR/MR headsets; |
| Alpha/Chroma | video stream | playback | Spatial (multi- | matte | holographic conferencing |
| 3-D Renderer | (alpha or | | view) | extraction; | |
| | keyed) | | | stereoscopic | |
| | | | | compositing | |
| Dual-Lens 3D | Dual-lens | Live | SBS, Spatial | Aligns dual | Dual-camera phones → remote |
| WebRTC | camera | publish via | (multi-view) | cameras; | AR glasses, VR/MR headsets |
| Streaming | capture | WebRTC | | merges into | |
| Pipeline | | | | SBS frame; | |
| | | | | streams 3-D | |
| | | | | feed | |
| Stereoscopic | Dual-lens | Live | SBS, Spatial | Aligns dual | Dual-camera phones → remote |
| Camera | camera | publish via | (multi-view) | cameras; | AR glasses, VR/MR headsets |
| WebRTC | capture | WebRTC | | merges into | |
| Streaming | | | | SBS frame; | |
| Pipeline | | | | streams 3-D | |
| | | | | feed | |

Alpha-HEVC 2D Renderer: A shader-based offline 2D renderer is implemented to decode HEVC video with an embedded alpha channel. Each frame is decoded into a full-color image and a corresponding transparency mask. A GPU fragment shader then applies this alpha mask to blend the color image over a chosen background. This shader-based pipeline produces output frames with transparent regions, enabling video overlays in post-production or compositing workflows. The offline process can pre-render high-quality frames for 2D visualization.

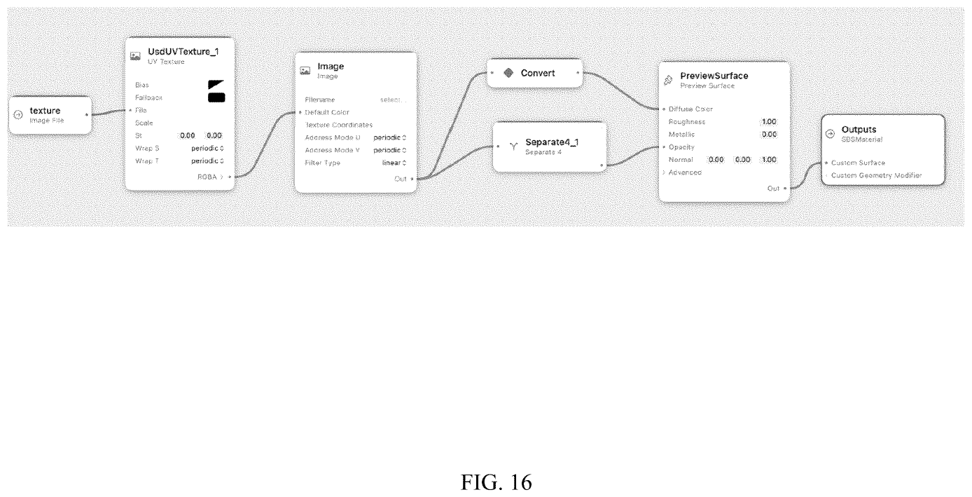

FIG. 16 depicts an Alpha-Channel 2D Shader Workflow in Apple Reality Composer Pro.

Alpha-HEVC 3D Renderer: The offline 3D renderer extends this approach to stereoscopic video. Two synchronized HEVC streams (left eye and right eye) with alpha layers are decoded in parallel. For each eye, the system extracts a color image and alpha mask, which a fragment shader applies to generate a transparency-enabled output. The resulting stereo frames can be formatted for side-by-side or top-bottom 3D playback. This offline 3D pipeline supports production of transparent 3D video content for VR or AR.

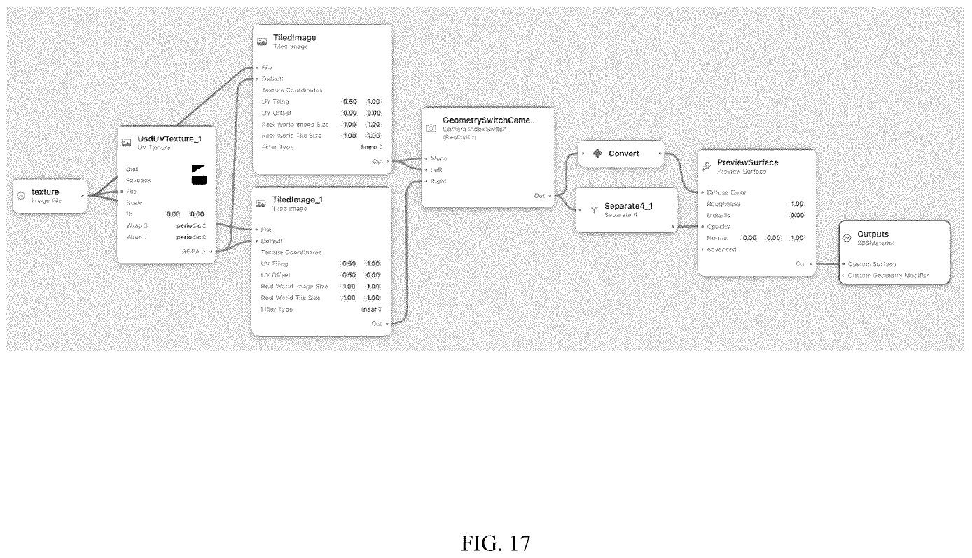

FIG. 17 depicts an Alpha-Channel 3D Shader Workflow in Apple Reality Composer Pro.

Chroma-Key 2D Renderer: For content encoded without a dedicated alpha channel, a chroma-key renderer is provided. The standard HEVC video (for example, with a uniform green-screen background) is decoded normally into color frames. A GPU shader identifies pixels matching the background chroma value and discards them, creating transparent areas. The offline chroma-key pipeline supports traditional green-screen workflows by removing the keyed color from each frame.

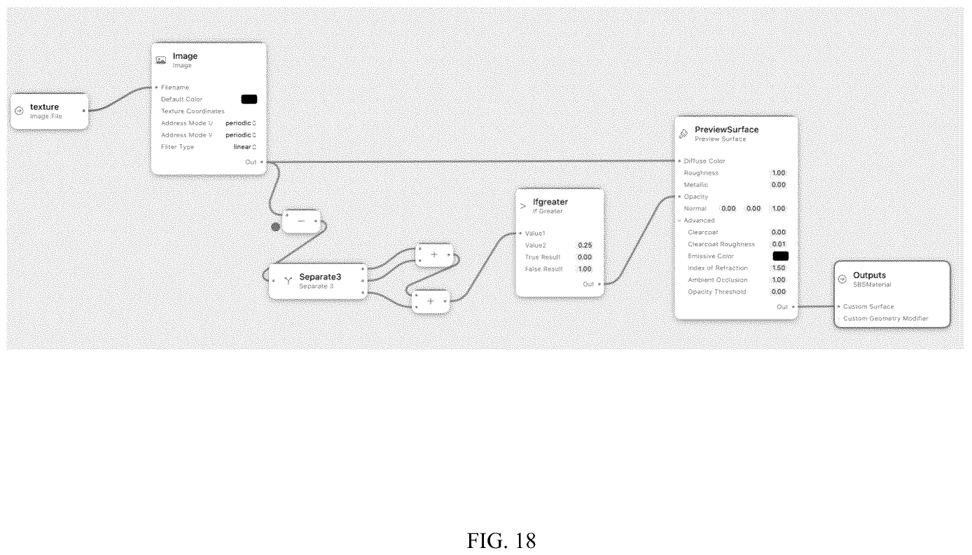

FIG. 18 depicts a Chroma-Key 2D Shader Workflow in Apple Reality Composer Pro.

Chroma-Key 3D Renderer: The 3D chroma-key renderer processes stereoscopic video with keyed backgrounds. Both left-eye and right-eye HEVC streams are decoded to color frames. Each view is passed through a GPU fragment shader that detects and removes the specified chroma (e.g. green) from the image. The outputs are synchronized stereo images with the background made transparent. This enables removal of uniform backgrounds from 3D footage in offline rendering and facilitates compositing of the stereo content into 3D scenes.

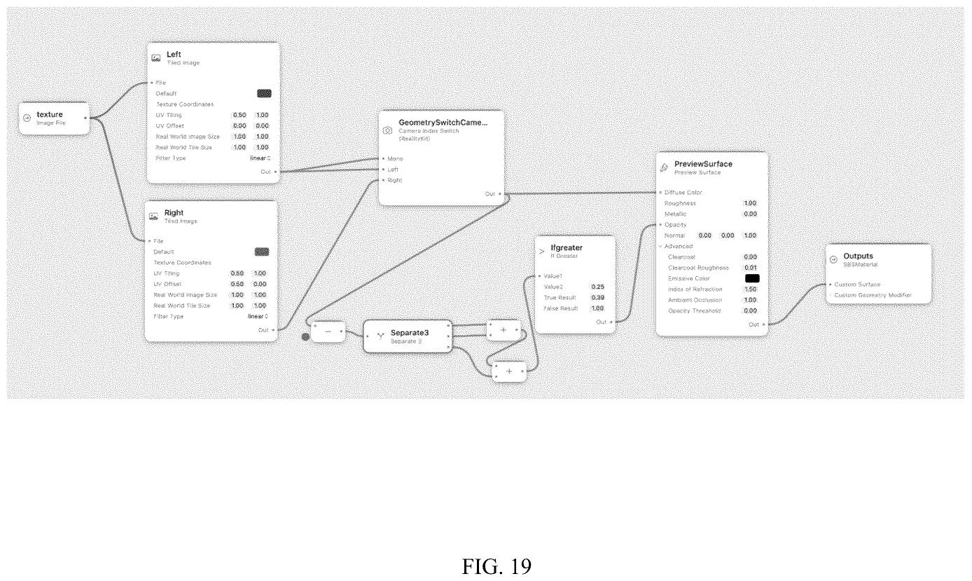

FIG. 19 depicts a Chroma-Key 3D Shader Workflow in Apple Reality Composer Pro.

Real-Time Chroma-Key 2D Renderer: In real-time 2D streaming scenarios, a chroma-based transparency pipeline is used. Incoming HEVC video—captured against a solid-color background such as green or blue—is transmitted over WebRTC as a standard video stream. A GPU shader on the receiving device identifies and removes pixels matching the designated chroma key, producing a transparent output in real time. This enables live overlay of people or objects in AR environments on mobile or wearable devices, without requiring alpha channel support.

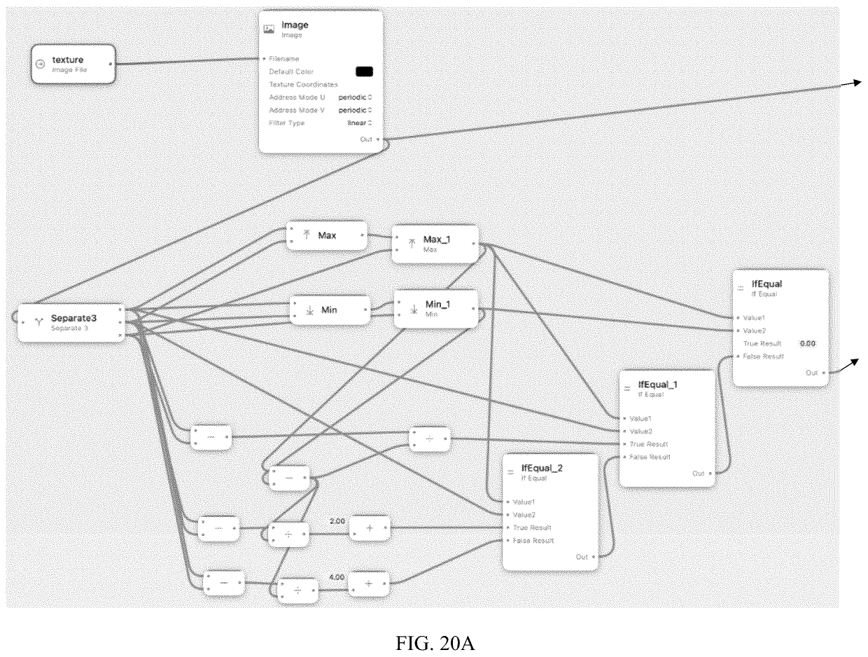

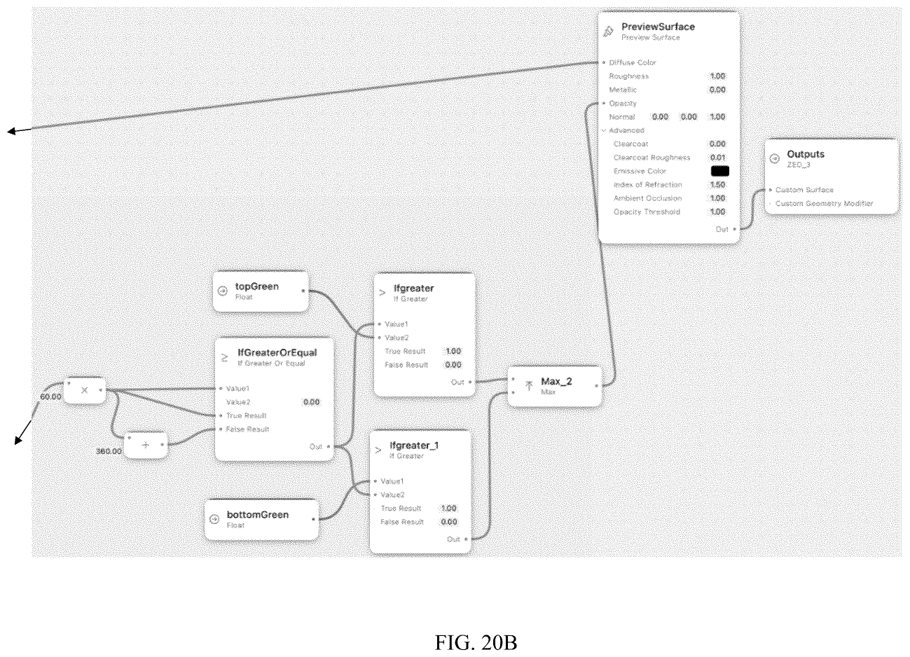

FIGS. 20A & 20B depict a Real-Time Chroma-Key 2D Shader Workflow in Apple Reality Composer Pro.

Real-Time Chroma-Key 3D Renderer: For stereoscopic video, synchronized left and right camera feeds are composited into a single side-by-side frame. This unified stereo frame is encoded and transmitted as a single HEVC video stream via WebRTC. On the receiving device, a shader separates the composite frame into two views and applies chroma-key background removal independently to each eye. The result is a transparent stereoscopic stream that can be rendered in AR/VR headsets with low latency and without the need for alpha channel encoding.

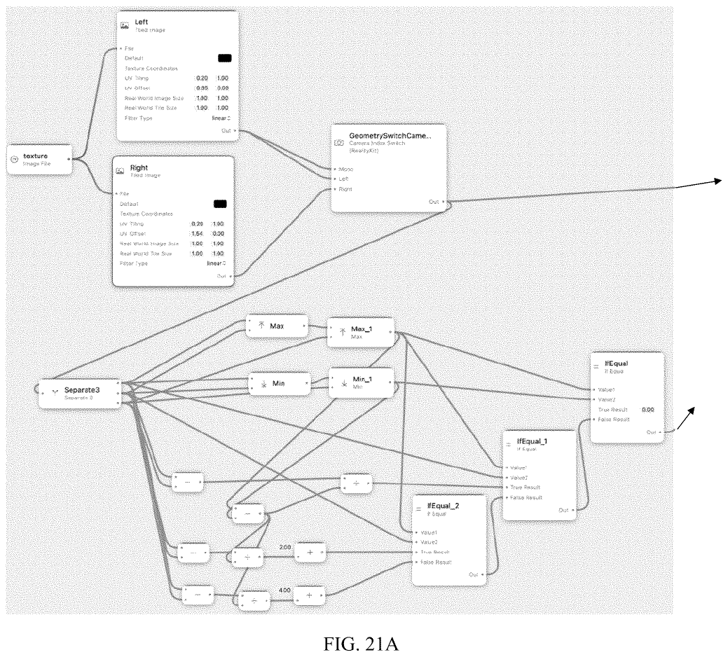

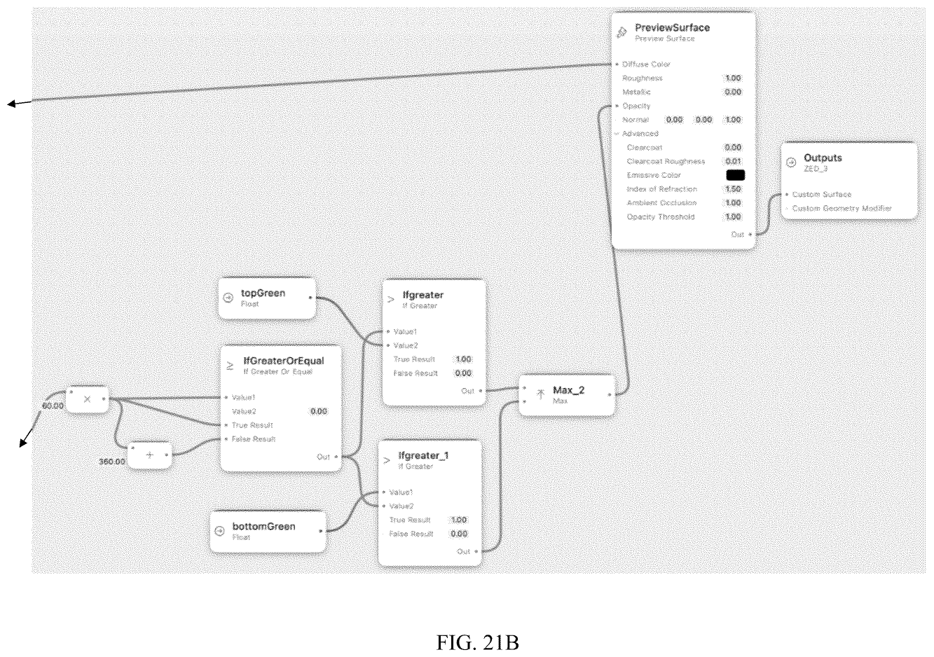

FIGS. 21A & 21B depict a Real-Time Chroma-Key 3D Shader Workflow in Apple Reality Composer Pro.

Some embodiments described present an AI-driven workflow for generating keyed or fully transparent video holograms and a device-agnostic playback stack that together eliminate the need for traditional green-screen stages. By producing holographic assets (removing subjects from their environment to a virtual background directly from text-based or programmatic descriptions, packaging synchronized multi-format outputs in a single container, and compositing them with a single-pass GPU shader), the system: Reduces capture and post-production costs by roughly an order of magnitude; Delivers frame-accurate 2-D, stereoscopic, spatial-video (multi-view), 180°, and 360° versions from a single source; Runs consistently across browsers, mobile devices, and XR wearables without platform-specific rewrites; Enables new products and services in training, retail, broadcast, entertainment, sports, and live events.

By abstracting production from physical constraints, the workflow future-proofs content pipelines and places early adopters at the forefront of next-generation immersive media.

In accordance with some embodiments, a method of providing an AI-generated hologram may include receiving, by one or more processors, a content-generation request defining a desired holographic subject, object, person, character, prop, scene, environment, or combination thereof. The content-generation request may include one or more prompts, scripts, images, videos, audio files, three-dimensional models, style references, metadata, camera parameters, lighting parameters, lens parameters, color-grading parameters, motion-path parameters, depth-of-field parameters, or other cinematography tokens. Based on the content-generation request, the one or more processors may generate holographic media representing the subject, object, person, character, prop, scene, or environment. The generated holographic media may include still image data, two-dimensional video data, stereoscopic three-dimensional video data, spatial-video or multi-view data, 180-degree video data, 360-degree video data, volumetric or pseudo-volumetric video data, or combinations thereof.

In some embodiments, the method may include selecting a background mode for the holographic media. The background mode may include a keyed background, such as a green-screen background, a blue-screen background, or a user-defined chroma-key color; an arbitrary synthetic background; a transparent background; an alpha-channel background; or no background. In certain embodiments, the background mode may be selected before generation of the holographic media such that the generated media is natively produced with the selected background mode. In other embodiments, the background mode may be applied after generation by segmenting the subject from an originally generated or captured background, replacing the original background with a chroma-keyable color, generating an alpha mask, or otherwise producing transparent or keyed output suitable for compositing.

In some embodiments, the method may include encoding the holographic media into one or more playback formats. For example, the method may include generating, from a common source generation or a common source asset, one or more synchronized outputs including two-dimensional video, stereoscopic three-dimensional video, side-by-side video, over-under video, spatial multi-view video, 180-degree immersive video, 360-degree immersive video, alpha-channel video, HEVC video with alpha information, keyed-background video, or still-frame image sequences. The method may further include packaging the one or more outputs with metadata indicative of the selected background mode, color key, alpha mask, stereoscopic arrangement, spatial-view arrangement, camera path, scale, intended display mode, device compatibility, or rendering parameters.

In some embodiments, the method may include delivering the encoded holographic media to a presentation device. The presentation device may include a web browser, mobile device, tablet, desktop computer, television, AR headset, VR headset, MR headset, XR headset, AR glasses, stereoscopic display, holographic display, or other display device. The holographic media may be delivered as a stored file, a progressive download, a real-time stream, a WebRTC stream, a low-latency communication stream, or any other suitable transmission format. In some embodiments, the same source media may be rendered differently depending on the capabilities of the presentation device, such as by selecting a two-dimensional rendering path for a mobile browser, a stereoscopic rendering path for a headset, or a spatial multi-view rendering path for an immersive display.

In some embodiments, the method may include decoding, by the presentation device or by an associated computing device, the holographic media using a hardware decoder, software decoder, adaptive decoder, or combination thereof. A shader, such as a GPU fragment shader or other graphics-processing kernel, may then be applied to the decoded frames. Where the holographic media includes an alpha channel, the shader may composite the subject using alpha data and discard or render transparent pixels. Where the holographic media includes a keyed background, the shader may identify pixels corresponding to a selected chroma-key color and remove, discard, or make transparent those pixels. The shader may further apply a threshold, slope, smoothing parameter, spill-suppression parameter, edge-refinement parameter, or opacity parameter to improve boundary quality around the rendered subject. In stereoscopic or spatial embodiments, the shader may apply the alpha-channel or chroma-key operation separately to left-eye and right-eye views or to multiple spatial views.

In some embodiments, the method may include rendering the holographic media into a physical or virtual environment. For example, the method may include receiving sensor data, camera data, depth data, plane-detection data, position data, orientation data, or mapping data from the presentation device; identifying a floor, wall, table, stage, screen, surface, room boundary, focal plane, anchor point, or other placement location; and placing the holographic subject at a selected position relative to the detected environment. The method may further include scaling the holographic subject to a selected real-world size, maintaining perspective as a viewer moves, occluding at least part of the holographic subject behind real or virtual objects, or modifying the rendering based on lighting, depth, position, user input, or device movement.

In some embodiments, the method may include a real-time streaming workflow. A live subject may be captured by one or more cameras, including a dual-lens mobile camera, stereoscopic camera, depth camera, or multi-camera system. Left-eye and right-eye frames, or other multi-view frames, may be aligned, cropped, synchronized, color-matched, resized, combined into a side-by-side or other composite frame, encoded as a single video stream, and transmitted to a remote presentation device. At the receiving device, the composite frame may be decoded, split into separate views, processed by an alpha or chroma shader, and rendered to the corresponding eyes of a stereoscopic or XR display. This method may allow low-latency three-dimensional telepresence without requiring separate transmission channels for each eye.

Artificial intelligence may be incorporated at one or more stages of the disclosed methods. In some embodiments, one or more AI models may generate the holographic media from text prompts, reference images, reference videos, audio inputs, scripts, motion data, three-dimensional assets, user preferences, or contextual information. The AI models may include, by way of non-limiting example, generative video models, diffusion models, transformer-based models, large language models, image-to-video models, text-to-video models, neural rendering models, segmentation models, depth-estimation models, pose-estimation models, style-transfer models, super-resolution models, frame-interpolation models, or combinations thereof. In some embodiments, AI may determine or refine cinematography tokens, generate camera motion, select lighting and lens parameters, maintain subject consistency across frames, generate alpha masks, improve edge boundaries, suppress chroma spill, estimate depth, infer occlusion relationships, convert two-dimensional content into stereoscopic or spatial content, or select an optimal output format for a target device.

In some embodiments, the AI may be trained, fine-tuned, prompted, conditioned, or otherwise configured based on training data including images, videos, keyed video clips, transparent video clips, depth maps, stereoscopic clips, spatial-video clips, segmentation masks, human-pose data, object-pose data, scene-layout data, cinematography metadata, or user feedback. The AI may operate locally on the presentation device, remotely on a cloud server, on an edge device, or across distributed computing resources. In certain embodiments, the AI may receive feedback from the playback stack or presentation device, such as frame rate, latency, decoder capability, segmentation quality, shader performance, battery state, user interaction, viewing angle, display type, or network bandwidth, and may modify generation, encoding, streaming, or rendering parameters in response. For example, the AI may reduce output resolution, change a codec, simplify a background mode, adjust a chroma key, modify an alpha mask, generate a different view arrangement, or select a lower-latency rendering path for a particular device or network condition.

In some embodiments, the method may include storing a generated holographic asset, associated prompts, model parameters, cinematography tokens, background settings, encoder settings, shader parameters, device profiles, or rendering metadata for later reuse. The stored information may allow the same holographic subject or performance to be regenerated, edited, reformatted, or rendered for different devices, environments, aspect ratios, background modes, or immersive display formats without requiring a physical green-screen reshoot. Accordingly, the disclosed methods may provide a unified workflow for AI generation, background isolation, multi-format encoding, device-adaptive decoding, shader-based transparent playback, and real-time or offline holographic presentation.

The following publications are incorporated herein by reference in their entireties: U.S. Pat. Nos. 12,118,681; 11,568,613; 11,074,759.

In the foregoing Detailed Description, it can be seen that various features are grouped together in a single embodiment for the purpose of clarity and brevity of the disclosure. This method of disclosure is not to be interpreted as reflecting an intention that the embodiments require more features than are expressly recited herein. Rather, the disclosure is to encompass all variations and modifications to the disclosed embodiments that would be understood to the skilled artisan in light of the disclosure.

### EXPERIMENTAL EXAMPLES

Embodiments disclosed herein are further described in detail by reference to the following experimental examples. These examples are provided for purposes of illustration only, and are not intended to be limiting unless otherwise specified. Thus, the embodiments of the disclosure should in no way be construed as being limited to the following examples, but rather, should be construed to encompass any and all variations which become evident as a result of the teaching provided herein.

Without further description, it is believed that one of ordinary skill in the art can, using the preceding description and the following illustrative examples, make and utilize the present embodiments and practice the claimed methods. The following working examples therefore are not to be construed as limiting in any way the remainder of the disclosure.

### Example 1: Pipeline for Removing any Color or Colors from a Video Stream in Real-Time

Disclosed herein is illustrative code excerpt that may be employed to remove any color or colors from a video stream in real-time. It is typical for a disassociated subject of a video to be provided through the use of a “green screen”. The base processing provided herein, such as the executable code below, allows for the providing of a virtual, rather than an actual, green screen, and hence are much more efficient and require substantially less equipment than does the known art. That is, as a feed is received or rendered, any color or colors, shapes, focal plane locations, focal points, or the like, may be removed from the video as it is rendered to and by the processing.
public static void ChromaKeyAlphaBlit (Texture2D input, RenderTexture output, Color color, float
range, float hueRange, float opacity=1.0f, float edgeSharpness=20.0f)

```
{
  ChromaKeyAlphaBlit(input, output, color, range, hueRange, opacity , edgeSharpness,
Vector2.zero, Vector2.one, false, false, Vector4.zero);
}
public static void ChromaKeyAlphaBlit(Texture2D input, RenderTexture output, Color
color, float
range, float hueRange, float opacity , float edgeSharpness, Vector2 shift, Vector2
multiplier,
bool flipH, bool flipV, Vector4 crop)
{
  Material mat = alphaMat;
  SetShiftAndMultiplier(mat, shift, multiplier, flipH, flipV);
  mat.SetColor(“_CKCol”, color);
  mat.SetFloat(“_Range”, range);
  mat.SetFloat(“_HueRange”, hueRange);
  mat.SetFloat(“_Opacity”, opacity);
  mat.SetFloat(“_EdgeSharp”, edgeSharpness);
  mat.SetVector(“_Crop”, crop);
  Graphics.Blit(input,output,mat);
}
public static void SetShiftAndMultiplier(Material mat, Vector2 shift, Vector2 multiplier,
bool flipH, bool flipV)
{
  if (flipH)
  {
    mat.SetFloat(“_uvDefX”, 1.0f + shift.x);
    mat.SetFloat(“_uvCoefX”,−1.0f / multiplier.x);
  }
  else
  {
    mat.SetFloat(“_uvDefX”,0.0f − shift.x);
    mat.SetFloat(“_uvCoefX”, 1.0f / multiplier.x);
  }
  if (flipV)
  {
    mat.SetFloat(“_uvDefY”, 1.0f + shift.y);
    mat.SetFloat(“_uvCoefY”,-1.0f / multiplier.y);
  }
  else
  {
    mat.SetFloat(“_uvDefY”,0.0f − shift.y);
    mat.SetFloat(“_uvCoefY”, 1.0f / multiplier.y);
  }
}
public void SetTexture( )
{
  if (webCamTexture != null && webCamTexture.isPlaying)
  {
    webCamTexture. Stop( );
  }
  if (webCamTexture != null)
    webCamTexture.deviceName = devName;
  else
    webCamTexture = new WebCam Texture(devName);
  webCamTexture.Play( );
}
void OnRenderImage (RenderTexture sourceTexture, RenderTexture destTexture) //
sourceTexture
is the source texture, destTexture is the final image that gets to the screen
{
  switch (srcType)
  {
    case ChromaKeySource.Device:
      Shader.SetGlobalTexture(“_UChromaKeyTex”, webCamTexture);
      break;
    case ChromaKeySource.Texture:
      Shader.SetGlobalTexture(“_UChromaKeyTex”, chromaKeyTexture);
      break;
  }
  Shader.SetGlobal Vector(“_Crop”, crop);
  if (flipHorizontal)
  {
    Shader.SetGlobalFloat(“_uvDefX”, 1.0f + uvShift.x);
    Shader.SetGlobalFloat(“ uvCoefX”, −1.0f / uvCoef.x);
  }
  else
  {
    Shader.SetGlobalFloat(“_uvDefX”, 0.0f − uvShift.x);
    Shader.SetGlobalFloat(“_uvCoefX”, 1.0f / uvCoef.x);
  }
  if (flip Vertical)
  {
    Shader.SetGlobalFloat(“_uvDefY”, 1.0f + uvShift.y);
    Shader.SetGlobalFloat(“_uvCoefY”, −1.0f / uvCoef.y);
  }
  else
  {
    Shader.SetGlobalFloat(“_uvDefY”, 0.0f − uvShift.y);
    Shader.SetGlobalFloat(“_uvCoefY”, 1.0f / uvCoef.y);
  }
  if (imageEffect)
  {
    material.SetColor(“_PatCol”, SelectedColor);
    if (threeColors)
    {
      material.SetColor(“ PatCol2”, SelectedColor2);
      material.SetColor(“_PatCol3”, SelectedColor3);
    {
    material.SetFloat(“_Range”, Range);
    if (!shaderModel2)
      material.SetFloat(“_HueRange”, HueRange);
    material.SetFloat(“_opacity”, opacity);
    material.SetFloat(“_smoothing”, edgeSharpness);
    RenderTexture tempRT =
      RenderTexture.GetTemporary(sourceTexture.width, sourceTexture.height, 0);
    Graphics.Blit(sourceTexture, tempRT, curMaterial);
    Graphics.Blit(tempRT, destTexture);
    RenderTexture.ReleaseTemporary(tempRT);
    //Graphics.Blit(sourceTexture, destTexture, curMaterial);
  }
  else
  }
    Graphics.Blit(sourceTexture, destTexture);
  }
}
//
// Use this for initialization
void Start ( ) {
  if(!SystemInfo.supportsImageEffects)
  {
    enabled = false;
    return;
  }
  devicesExist = true;
  WebCamDevice[ ] devices = WebCamTexture.devices;
  if (devices. Length == 0)
    devicesExist = false;
  if (SourceType == ChromaKeySource.Device && autoSetDevice && devicesExist)
  {
    DeviceName = devices[0].name;
  }
}
void Update ( )
{
  switch (srcType)
  {
    case ChromaKeySource.Device:
      Shader.SetGlobalTexture(“_UChromaKeyTex”, webCamTexture);
      break;
    case ChromaKeySource.Texture:
      Shader.SetGlobalTexture(“_UChromaKeyTex”, chromaKeyTexture);
      break;
  }
  Shader.SetGlobalVector(“_Crop”, crop);
  if (flipHorizontal)
  {
    Shader.SetGlobalFloat(“ uvDefX”, 1.0f + uvShift.x);
    Shader.SetGlobalFloat(“_uvCoefX”, −1.0f / uvCoef.x);
  }
  else
  {
    Shader.SetGlobalFloat(“_uvDefX”, 0.0f − uvShift.x);
    Shader.SetGlobalFloat(“_uvCoefX”, 1.0f / uvCoef.x);
  }
  if (flipVertical)
  {
    Shader.SetGlobalFloat(“_uvDefY”, 1.0f + uvShift.y);
    Shader.SetGlobalFloat(“_uvCoefY”, −1.0f / uvCoef.y);
  }
  else
  {
    Shader.SetGlobalFloat(“_uvDefY”, 0.0f − uvShift.y);
    Shader.SetGlobalFloat(“_uvCoefY”, 1.0f / uvCoef.y);
  }
}
```

### Example 2: Dual-Lens 3D WebRTC Streaming Pipeline

Disclosed herein is a Real-Time Dual-Lens Frame Processing Workflow. A real-time stereo streaming system is implemented using a dual-lens camera setup. The left and right video frames are captured simultaneously, aligned in software to match field-of-view and perspective, and composited into a single side-by-side image. This combined stereo frame is encoded (e.g., using HEVC) and transmitted over WebRTC as a single video track, maintaining synchronization between views while minimizing bandwidth and stream complexity.

On the receiving end, the decoded side-by-side frame is split by a shader into left and right views and rendered to the corresponding eyes in a stereoscopic display or AR headset. This architecture enables low-latency 3D video streaming using standard WebRTC pipelines, without requiring dual-stream support or specialized decoding infrastructure. An illustrative code excerpt is disclosed herein.

```
  func captureOutput(_ output: AVCaptureOutput, didOutput sampleBuffer:
  CMSampleBuffer, from connection: AVCaptureConnection) {
    if let videoDataOutput = output as? AVCapture VideoDataOutput
      if videoTrackSourceFormatDescription == nil {
        videoTrackSourceFormatDescription =
  CMSampleBufferGetFormatDescription(sampleBuffer)
      }
      guard renderingEnabled else {
        return
      let timestamp = CMSampleBufferGetPresentationTimeStamp(sampleBuffer)
      let xPadding = yPadding * originalWidth / 1080
      if videoDataOutput == wide VideoDataOutput {
        guard let pixelBuffer = CMSampleBufferGetImageBuffer(sampleBuffer) else {
          return
        }
        let newSize = CGSize(width: self.originalHeight - 2*self.yPadding, height:
  self.originalWidth - 2*xPadding)
        guard let resizedPixelBuffer = resizePixelBuffer(pixelBuffer, targetSize:
  newSize) else {
          return
        }
        ultraWidePixelBuffer = resizedPixelBuffer
        DispatchQueue.main.async {
          if self.debugButton.isSelected {
            var cilmage = CIImage(cvImageBuffer: resizedPixelBuffer)
            ciImage = ciImage.transformed(by: CGAffineTransform(rotationAngle: (.pi /
  2)))
            guard let cgImage = self.context.createCGImage(ciImage, from:
  ciImage.extent) else {
              return
            }
              //right
            self.ultraWideCamImage View.image = UIImage(cgImage: cgImage)
          }
        }
      } else {
        guard let pixelBuffer = CMSampleBufferGetImageBuffer(sampleBuffer) else {
          return
        }
        let frame = CGRect(x: yPadding, y: xPadding, width: originalHeight -
  2*yPadding, height: originalWidth - 2*xPadding)
        widePixelBuffer = cropPixelBuffer(pixelBuffer, cropRect: frame)
        guard let widePixelBuffer = widePixelBuffer else {
          return
        }
        var ciImage = CIImage(cvImageBuffer: widePixelBuffer)
        ciImage = ciImage.transformed(by: CGAffineTransform(rotationAngle: (.pi / 2)))
        guard let cgImage = context.createCGImage(ciImage, from: ciImage.extent) else
  {
          return
  }
  let wideImage = UIImage(cgImage: cgImage)
  DispatchQueue.main.async {
    if self.debugButton.isSelected {
      self.wideCamImageView.image = wideImage
    } else {
      self.fullImageView.image = wideImage
    }
  }
  if let lastTimeStamp = lastTimeStamp, localUserId != 0, let agoraKit = self.agoraKit,
  agoraKit.getConnectionState( ) == . connected {
    let timeDif = timestamp - lastTimeStamp
    //print(“timeDif \(timeDif.seconds)”)
    DispatchQueue.main.async {
      guard timeDif.seconds < 0.01, let ultraWidePixelBuffer = self.ultraWidePixelBuffer,
  let widePixelBuffer = self. widePixelBuffer, self.trackId != 0 else {
        return
      }
      guard let textureBuf = self.createSideBySideImageBuffer(buffer1: widePixelBuffer,
buffer2: ultraWidePixelBuffer) else {
        return
      }
      //print(“frameSent: \(CMTimeGetSeconds(timestamp))”)
      let new VideoFrame = AgoraVideoFrame( )
      newVideoFrame.time = timestamp
      // newVideoFrame.strideInPixels = Int32(self.frameWidth)
      // newVideoFrame.height = Int32(self.frameHeight)
      newVideoFrame.textureBuf = textureBuf
      newVideoFrame.format = 12
      let result = agoraKit.pushExternalVideoFrame(newVideoFrame, videoTrackId:
  UInt(self.trackId))
    }
  }
  lastTimeStamp = timestamp
  }
}
```

### Example 3: Stereoscopic Camera WebRTC Streaming Pipeline

A real-time 3D streaming system is implemented using a stereoscopic camera that captures left-eye and right-eye frames in parallel. Each frame pair is aligned in software to match perspective and field-of-view, then composited into a single side-by-side image. This unified stereo frame is encoded (e.g., using HEVC) and transmitted as a single video track over WebRTC, preserving depth fidelity while reducing stream complexity.

On the receiving end, the side-by-side frame is decoded and split in real time using a GPU shader, which maps each half of the frame to the corresponding eye in an AR headset or stereoscopic display. This pipeline enables efficient, low-latency transmission of 3D video using standard WebRTC infrastructure, without requiring dual-channel signaling or custom decoding logic.

The disclosures of each and every patent, patent application, and publication cited herein are hereby each incorporated herein by reference in their entirety. While this disclosure has been disclosed with reference to specific embodiments, it is apparent that other embodiments and variations of this disclosure may be devised by others skilled in the art without departing from the true spirit and scope of the disclosure. The appended claims are intended to be construed to include all such embodiments and equivalent variations.

What is claimed is:

1. A system for providing AI-generated holograms, comprising:
one or more processors configured to implement a content generator including a generative video engine, the content generator configured to synthesize holographic media representing at least one subject, person, object, prop, scene, or environment based at least in part on parameterized cinematography tokens including at least one of lighting, a lens parameter, a motion path, depth of field, camera motion, or color grading; and
a playback stack including a shader executable by a graphics processing unit, the shader configured to remove a keyed background from the holographic media or to composite the holographic media using alpha-channel data.

2. The system of claim 1, wherein the content generator further comprises a background selector configured to output the holographic media with a background selected from the group consisting of a solid green background, a user-defined keyed-color background, and a transparent background.

3. The system of claim 1, wherein the content generator further comprises a multi-format encoder configured to encode synchronized outputs of the holographic media in at least one format selected from the group consisting of two-dimensional video, stereoscopic three-dimensional video, spatial multi-view video, 180-degree video, and 360-degree video.

4. The system of claim 1, wherein the playback stack further comprises an adaptive decoder configured to use a hardware codec pipeline of a host device to decode the holographic media.

5. The system of claim 1, wherein the content generator is configured to generate still holographic media or video holographic media for real-time live use or post-production of pre-recorded media.

6. The system of claim 1, wherein the shader is configured to apply at least one of a chroma-key threshold, a slope parameter, an edge-smoothing parameter, an opacity parameter, or a spill-suppression parameter to refine a boundary of the at least one subject, person, object, prop, scene, or environment.

7. The system of claim 1, wherein the holographic media comprises stereoscopic or spatial-view media, and wherein the shader is configured to apply background removal or alpha compositing separately to a plurality of views of the stereoscopic or spatial-view media.

8. The system of claim 1, wherein the playback stack is configured to receive the holographic media as a real-time stream and render the holographic media as a transparent overlay on a web browser, mobile device, AR headset, VR headset, MR headset, XR headset, or AR glasses.

9. The system of claim 1, wherein the one or more processors are configured to receive environmental data from a presentation device and place the holographic media at a selected position relative to a detected surface, focal plane, anchor point, or depth map of a physical or virtual environment.

10. The system of claim 1, wherein an artificial intelligence model is configured to modify at least one of generation, encoding, streaming, or rendering of the holographic media based on device capability, network bandwidth, frame rate, latency, segmentation quality, shader performance, or user feedback.

11. A method for providing AI-generated holographic media, comprising:
receiving, by one or more processors, a content-generation request defining at least one subject, person, object, prop, scene, or environment;
synthesizing, using a generative video engine, holographic media representing the at least one subject, person, object, prop, scene, or environment based at least in part on parameterized cinematography tokens;
selecting a background mode for the holographic media, the background mode comprising a keyed background or alpha-channel transparency;
encoding the holographic media in at least one playback format; and
rendering the holographic media using a shader executed by a graphics processing unit, wherein the shader removes the keyed background from the holographic media or composites the holographic media using alpha-channel data.

12. The method of claim 11, wherein the content-generation request comprises at least one of a text prompt, reference image, reference video, script, audio input, three-dimensional model, style reference, user preference, or cinematography parameter.

13. The method of claim 11, wherein an artificial intelligence model predicts, based on a target presentation device or network condition, at least one of an output format, codec, resolution, frame rate, stereoscopic arrangement, spatial-view arrangement, or rendering path for the holographic media.

14. The method of claim 11, wherein an artificial intelligence model modifies at least one of a chroma-key color, chroma-key threshold, alpha mask, edge-smoothing parameter, spill-suppression parameter, output resolution, frame rate, or codec in response to detected playback performance.

15. The method of claim 11, further comprising generating, using an artificial intelligence model, a recommendation to change at least one of a prompt, lighting parameter, lens parameter, camera motion, depth-of-field parameter, background mode, output format, or placement location of the holographic media.

16. The method of claim 11, further comprising displaying to a user a preview of the holographic media on at least one selectable background mode including a keyed-color background, transparent background, physical environment background, or virtual environment background.

17. The method of claim 11, further comprising displaying to a user a predicted playback condition comprising at least one of expected latency, frame rate, bandwidth usage, battery usage, decoder compatibility, shader compatibility, or rendering quality.

18. The method of claim 11, further comprising displaying to a user an environmental placement interface identifying at least one detected surface, focal plane, anchor point, depth region, occlusion boundary, or scale indicator for positioning the holographic media.

19. The method of claim 11, wherein rendering the holographic media comprises applying the shader separately to left-eye and right-eye views, or to a plurality of spatial views, to provide transparent stereoscopic or spatial-view playback.

20. The method of claim 11, wherein an artificial intelligence model generates or modifies at least one of a segmentation mask, alpha mask, depth map, pose estimate, occlusion map, missing view, interpolation frame, or super-resolution frame for the holographic media.
